(19) United States
(12) Patent Application Publication
(10) Pub. No.: US 2025/0073668 A1
(43) Pub. Date: Mar. 6, 2025

(54) CARBON DIOXIDE SORBENT MOLECULES, PROCESSES OF MAKING, AND USES

(71) Applicant: Hexion Inc., Columbus, OH (US)

(72) Inventors: Daniel PACHECO, Springfield, OR (US); Gregory D. BRINER, Springfield, OR (US); Sejal Sanjeev SHETH, Springfield, OR (US)

(21) Appl. No.: 18/817,620

(22) Filed: Aug. 28, 2024

Related U.S. Application Data
(60) Provisional application No. 63/535,493, filed on Aug. 30, 2023.

(51) Int. Cl. B01J 20/22; B01D 53/62; B01D 53/78; B01D 53/96; B01J 20/34

(52) U.S. Cl. CPC B01J 20/22; B01D 53/62; B01D 53/78; B01D 53/96; B01J 20/3483; B01D 2252/20436; B01D 2252/60; B01D 2257/504; B01D 2258/06

(57) ABSTRACT

Embodiments of the present disclosure generally relate to carbon dioxide sorbent molecules and to processes for forming carbon dioxide sorbent molecules. Embodiments described herein also generally relate to processes for CO₂ absorption and CO₂ desorption. In an embodiment, a composition for absorbing or desorbing carbon dioxide is provided. The composition includes a carbon dioxide sorbent molecule. The carbon dioxide sorbent molecule includes a melamine-formaldehyde adduct or reaction product modified with an organoamine source, the organoamine source being different from melamine.

### CROSS-REFERENCE TO RELATED APPLICATIONS

This application claims benefit of and priority to U.S. Provisional Application Ser. No. 63/535,493, filed on Aug. 30, 2023, which is incorporated herein by reference in its entirety.

### FIELD

Embodiments of the present disclosure generally relate to carbon dioxide sorbent molecules and to processes for forming carbon dioxide sorbent molecules. Embodiments described herein also generally relate to processes for CO₂ absorption and CO₂ desorption.

### BACKGROUND

Carbon dioxide (CO₂) is a primary greenhouse gas that contributes significantly to global warming and climate change, owing to the excessive emissions from the combustion of fossil fuels. Direct air capture, which is the extraction of CO₂ directly from the atmosphere, is one strategy for reducing CO₂. In addition, two of the options actively being pursued to reduce CO₂ emissions are carbon capture and storage (CCS) and carbon capture storage and utilization (CCSU) technologies. One step in many CCS and CCSU technologies is the reversible binding (absorption and desorption) of a CO₂ molecule.

Currently, very few technologies exist for direct air capture of CO₂ for CCSU and CCS. Here, most conventional technologies for direct air capture include metal hydroxides such as sodium hydroxide and potassium hydroxide. Metal hydroxides can be cost effective for CO₂ absorption, but the energy cost to desorb CO₂ for generating value-added products is very high. This is due to the need to evaporate all of the water before being able to desorb CO₂ at very high temperatures of 800° C. to 1,200° C. The evaporation of water can be avoided by reacting with calcium hydroxide to precipitate out calcium carbonate but requires desorption temperatures of about 840° C.

Therefore, there is a need for new and improved sorbents and compositions for capturing and releasing CO₂. There is also a need for new and improved processes for capturing and releasing CO₂.

### SUMMARY

Embodiments described herein generally relate to carbon dioxide sorbent molecules and to processes for forming carbon dioxide sorbent molecules. Embodiments described herein also generally relate to processes for CO₂ absorption and CO₂ desorption. For CO₂ absorption and CO₂ desorption, a carbon dioxide sorbent molecule can be in the form of a solution or in the solid state. Embodiments described herein can outperform conventional CO₂ capture technologies. In addition, carbon dioxide sorbent molecules can be regenerated and recycled for further use after desorption of CO₂.

In an embodiment is provided a composition for absorbing or desorbing CO₂. The composition includes a carbon dioxide sorbent molecule comprising a melamine-formaldehyde reaction product modified with an organoamine source, the organoamine source being different from melamine.

In another embodiment is provided a composition for absorbing or desorbing CO₂. The composition includes a carbon dioxide sorbent molecule comprising a reaction product of: glyoxal; and an organoamine source comprising a urea functional group.

In another embodiment is provided a process that includes: contacting a gas stream comprising CO₂ with a composition comprising water, an additive, and a carbon dioxide sorbent molecule described herein; and precipitating a sorbent-CO₂ complex comprising CO₂ bound to the carbon dioxide sorbent molecule.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 shows distortionless enhancement by polarization transfer (DEPT) Carbon-13 nuclear magnetic resonance (¹³CNMR) spectra of an example carbon dioxide sorbent molecule.

FIG. 2 is an overlay of Fourier transfer mid-infrared (FT-MIR) spectra showing CO₂ absorption by an example carbon dioxide sorbent molecule.

FIG. 3 shows carbon-13 nuclear magnetic resonance (¹³C NMR) spectra of various materials used and made during synthesis of an example carbon dioxide sorbent molecule with an aminoguanidine.

FIG. 4 is an overlay of thermogravimetric analysis (TGA) data of CO₂ bound to an example carbon dioxide sorbent molecule.

FIG. 5A shows data for evolved gas analysis of a glyoxal-bis-iminoguanidine-CO₂ comparative example.

FIG. 5B shows data for evolved gas analysis of CO₂ bound to an example carbon dioxide sorbent molecule.

FIG. 6 shows data for mass gain as a function of CO₂ absorption time for an example carbon dioxide sorbent.

FIG. 7 shows ¹³C NMR spectra of various materials used and made during synthesis of an example carbon dioxide sorbent with a guanidine.

FIG. 8 is an overlay of FT-MIR spectra showing CO₂ desorption by an example carbon dioxide sorbent molecule.

FIG. 9 shows FT-MIR spectra of carbon dioxide desorbed from an example carbon dioxide sorbent molecule (top panel) and CO₂ alone (bottom panel).

FIG. 10 shows a plot of CO₂ absorption versus time for a first absorption-desorption cycle for a mixture comprising a carbon dioxide sorbent and a caustic solution at least one embodiment of the present disclosure.

Figures included herein illustrate various embodiments of the disclosure. It is contemplated that elements and features of one embodiment may be beneficially incorporated in other embodiments without further recitation.

### DETAILED DESCRIPTION

Embodiments described herein generally relate to carbon dioxide sorbent molecules and to processes for forming carbon dioxide sorbent molecules. Embodiments described herein also generally relate to processes for CO₂ absorption and CO₂ desorption. Compositions described herein can overcome challenges faced by conventional technologies for capture and release of CO₂ such as direct air capture (DAC). For example, compositions described herein can have significantly higher absorption and/or desorption efficiencies relative to conventional DAC technologies and other conventional technologies for capture and release of CO₂.

Briefly, and in some embodiments, the present disclosure provides compositions that include a carbon dioxide sorbent molecule and an optional solvent such as water. During use, the carbon dioxide sorbent molecule can be utilized in a process for removing CO₂ from a gaseous source. For example, the process can include introducing a gaseous source with a composition that includes a carbon dioxide sorbent molecule (e.g., an aminoguanidine-modified melamine-formaldehyde adduct or a guanidine-modified melamine-formaldehyde adduct). The composition can further include a solvent such that the composition is in the form of a solution or suspension. Additionally, or alternatively, the composition can be in the form of a solid-state composition. Additionally, or alternatively, the composition can be in the form of a saturating substrate or coating substrate that includes the carbon dioxide sorbent molecule. Contact between the CO₂ and the carbon dioxide sorbent molecule can result in complexation to form carbonate salts and/or bicarbonate salts of the carbon dioxide sorbent molecule. Complexation can result in precipitation and the precipitated salts can be removed from, for example, the solution or suspension. In some embodiments, the precipitated salt can be subjected to heat or other technique for separating (or release of) the CO₂ gas from the precipitated salt and at the same time regenerating the carbon dioxide sorbent molecule. The released CO₂ gas can be stored or used in a variety of applications.

The use of headings is for purposes of convenience only and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

As used herein, “a carbon dioxide-enriched composition” and “CO₂-enriched composition” means that the relative amount (or concentration) of CO₂ in a composition after exposure or contact with CO₂ is greater than the relative amount of CO₂ in a composition before the exposure or contact. For example, if a composition includes 1% CO₂ before exposure or contact with CO₂, the composition after exposure or contact with CO₂ would include greater than 1% CO₂. The CO₂ that is sequestered or trapped by one or more components of the composition can be in the form of carbonate (CO₃²⁻) salt, bicarbonate (HCO₃⁻) salt, a reaction product with one or more components of the composition (e.g., a urethane), or a physically bound CO₂ by electrostatic interactions, for example, Van der Waals forces.

As used herein, “a carbon dioxide-depleted composition” and “CO₂-depleted composition” means that the relative amount (or concentration) of CO₂ in a composition after desorption or release of CO₂ is less than the relative amount of CO₂ in a composition before desorption or release. For example, if a composition includes 1% CO₂ before desorption or release of CO₂, the composition after before desorption or release would include less than 1% CO₂.

In some embodiments is provided a carbon dioxide sorbent molecule that is capable of scavenging CO₂ gas. In some implementations, the carbon dioxide sorbent molecule is a formaldehyde derived molecule. The carbon dioxide sorbent molecule can be dissolved or suspended in an aqueous solution, or can be utilized in solid state.

In some embodiments, a carbon dioxide sorbent molecule is formed by reacting melamine with formaldehyde and then sulfonating the melamine-formaldehyde reaction product. Sulfonation can improve the water solubility of the carbon dioxide sorbent molecule. In some implementations, the sulfonated product is then reacted with aminoguanidine. The aminoguanidine group (or other organoamine group) can serve as the functional ligand to scavenge or bond CO₂. The scavenged or bound CO₂ with the aminoguanidine (or other organoamine group) can be in the form of, for example, a carbonate salt and/or bicarbonate salt. Guanidine or polyamine can be utilized instead of aminoguanidine.

Exposure of the carbon dioxide sorbent molecule to CO₂ gas can result in precipitation of the molecule out of solution. The precipitate can be filtered off if desired. In at least one implementation, the molecule can be heated to desorb CO₂. Embodiments described herein can enable CO₂ concentration.

Unlike conventional technologies for CO₂ absorption, carbon dioxide sorbent molecules described herein (and compositions thereof) can enable rapid absorption of CO₂ within about 30 seconds. Carbon dioxide sorbent molecules of the present disclosure, and compositions thereof, can have an absorption capacity that ranges from about 0.001 to 5.000 moles CO₂ per mole of carbon dioxide sorbent molecule, though other ranges are contemplated.

In addition, embodiments described herein can enable low-temperature desorption, such as less than about 160° C. In some non-limiting examples, desorption can be performed at a temperature of about 105° C. In other non-limiting examples, desorption temperatures can range from about 120° C. to about 130° C.

Unlike conventional technologies, carbon dioxide sorbent molecules described herein can be synthesized by a one-pot set-up. Further, the syntheses can also be free of organic solvents. In addition, the carbon dioxide sorbent molecules have improved solubility relative to state-of-the-art approaches, allowing for higher concentrations of solubilized active sorbent. In contrast, conventional syntheses of sorbents consistently utilize organic solvents during the synthesis, use multiple filtrations, and are limited to active concentrations of 1 mM or less.

### Compositions

Embodiments of the present disclosure generally relate to compositions for absorbing and/or desorbing CO₂. The compositions generally include a carbon dioxide sorbent molecule and one or more optional components. The one or more optional components can include a solvent, an additive, or combinations thereof.

When a solvent is included, the composition can be in the form of a solution or suspension that includes the carbon dioxide sorbent molecule and the solvent. Additionally, or alternatively, the carbon dioxide sorbent molecule can be used in solid-state.

### I.A. Carbon Dioxide Sorbent Molecules

In some embodiments, compositions for absorbing CO₂, desorbing CO₂, or both includes a carbon dioxide sorbent molecule that includes a reaction product or adduct of (a) melamine, (b) a formaldehyde, and (c) an organoamine, where the organoamine is different from the melamine. In at least one embodiment, the composition includes a carbon dioxide sorbent molecule that includes a reaction product or adduct of (a) an organoamine and (b) a reaction product or adduct of melamine and a formaldehyde, where the organoamine is different from the melamine.

Such carbon dioxide sorbent molecules can be represented by Formula (I-A):

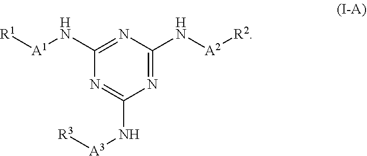

In Formula (I-A), each of A¹, A², and A³ can be, independently, methylene (—CH₂—), dimethylene ether (—CH₂—O—CH₂—), or other groups.

In Formula (I-A), each of R¹, R², and R³ can be, independently, a moiety that includes a functional group for bonding CO₂. Such moieties may be referred to as functional ligands. Bonding between the functional group of the moiety and the CO₂ can be physical bonding, chemical bonding, or combinations thereof. In some embodiments, at least one of R¹, R², and R³ can be a functional group that enables solubilization of the carbon dioxide sorbent molecule, such as a polar non-ionizable functional group, an ionizable functional group, or salt thereof. Including an ionizable functional group or a polar non-ionizable functional group can help improve solubility of the carbon dioxide sorbent molecule depending on, for example, the type of solvent utilized such as the polarity of the solvent, and/or whether it is an aqueous solvent or organic solvent. In some embodiments, at least one of R¹, R², and R³ can be a functional group that enables coupling or attachment to a solid support. Including a functional group that allows coupling or attachment (for example, by a chemical bond) to a solid support, the carbon dioxide sorbent molecule can be, for example, easily removed for CO₂ absorption or CO₂ desorption, from a system containing liquids.

In at least one embodiment, carbon dioxide sorbent molecules can be represented by Formula (I-B):

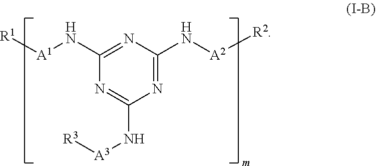

In Formula (I-B), each of A¹, A², and A³ can be, independently, methylene (—CH₂—), dimethylene ether (—CH₂—O—CH₂—), or other groups. In Formula (I-B), each of R¹, R², and R³ can be the same as R¹, R², and R³ of Formula (I-A). In Formula (I-B), m can be an integer from 1 to 1,000, such as from 1 to 100, such as from 1 to 10. Formula (I-B) includes a melamine-formaldehyde polymer or resin core to which R¹, R², and R³ are chemically coupled to.

Embodiments of Formula (I-A) described herein can apply to embodiments of Formula (I-B), unless specified to the contrary or the context clearly indicates otherwise.

As further described below, the core of Formula (I-A) can be formed from reaction of melamine with a formaldehyde, or derivatives thereof. The core of Formula (I-A) is represented by Formula (II-A):

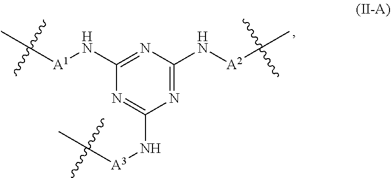

wherein, in Formula (II-A) the wavy bonds represent a connection to an R group, for example, R¹, R², and R³. A¹, A², and A³ of Formula (II-A) are described above.

Referring back to Formula (I-A), and in some embodiments, each of R¹, R², and R³ of Formula (I-A) can be, independently, hydrogen, unsubstituted hydrocarbyl, a substituted hydrocarbyl, or a functional group comprising at least one element from Group 13-17 of the periodic table of the elements. When an R group is a functional group comprising at least one element from Group 13-17, the R group can be halogen (F, Cl, Br, or I), O, N, Se, Te, P, As, Sb, S, B, Si, Ge, Sn, Pb, and the like, such as C(O)R*, C(C)NR*₂, C(O)OR*, NR*₂, OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like, where R* is, independently, hydrogen or unsubstituted hydrocarbyl, or where at least one heteroatom has been inserted within the unsubstituted hydrocarbyl.

Each of R¹, R², and R³ of Formula (I-A) can have, independently, any suitable number of carbon atoms such as from 1 to 20 carbon atoms, such as from 1 to 10 carbon atoms, such as from 1 to 5 carbon atoms, such as from 1 to 4 carbon atoms. In some embodiments, the number of carbon atoms in each of R¹, R², and R³ of Formula (I-A) can be, independently, 1, 2, 3, 4, 5, 6, 7, 8, 9, 10, 11, 12, 13, 14, 15, 16, 17, 18, 19, or 20. Each of the foregoing numbers can be preceded by the word “about,” “at least about,” “less than about,” or “more than about,” and any of the foregoing numbers can be used singly to describe an open-ended range or in combination to describe a close-ended range. Each of R¹, R², and R³ of Formula (I-A) can be, independently, linear or branched, saturated or unsaturated, cyclic or acyclic, aromatic or not aromatic. Regarding saturation, each of R¹, R², and R³ of Formula (I-A) can be, independently, fully saturated, partially unsaturated, or fully unsaturated.

In some examples, one or more of R¹, R², or R³ of Formula (I-A) can be an unsubstituted hydrocarbyl. An “unsubstituted hydrocarbyl” refers to a group that consists of hydrogen and carbon atoms only. Illustrative, but non-limiting, examples of unsubstituted hydrocarbyl include an alkyl group having from 1 to 20 carbon atoms such as methyl, ethyl, n-propyl, isopropyl, n-butyl, iso-butyl, sec-butyl, and tert-butyl, pentyl, hexyl, heptyl, octyl, ethyl-2-hexyl, isooctyl, nonyl, n-decyl, isodecyl, or isomers thereof; a cycloaliphatic group having from 3 to 20 carbon atoms such as, for example, cyclopentyl or cyclohexyl; an aromatic group having from 6 to 20 carbon atoms such as, for example, phenyl or naphthyl; or any combination thereof.

In some embodiments, one or more of R¹, R², or R³ of Formula (I-A) can be a substituted hydrocarbyl. A “substituted hydrocarbyl” refers to an unsubstituted hydrocarbyl in which at least one hydrogen of the unsubstituted hydrocarbyl has been substituted with at least one heteroatom or heteroatom-containing group, such as one or more elements from Group 13-17 of the periodic table of the elements, such as halogen (F, Cl, Br, or I), O, N, Se, Te, P, As, Sb, S, B, Si, Ge, Sn, Pb, and the like, such as C(O)R*, C(C)NR*₂, C(O)OR*, NR*₂, OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like, where R* is, independently, hydrogen or unsubstituted hydrocarbyl, or where at least one heteroatom has been inserted within the unsubstituted hydrocarbyl.

As used herein, reference to an R group, alkyl, substituted alkyl, hydrocarbyl, or substituted hydrocarbyl without specifying a particular isomer (such as butyl) expressly discloses all isomers (such as n-butyl, iso-butyl, sec-butyl, and tert-butyl). For example, reference to an R group having 4 carbon atoms expressly discloses all isomers thereof. When a compound is described herein such that a particular isomer, enantiomer, or diastereomer of the compound is not specified, for example, in a formula or in a chemical name, that description is intended to include each isomer and enantiomer of the compound described individual or in any combination.

### I.A.1. R Groups as Organoamine Groups

In some embodiments, one or more of R¹, R², or R³ of Formula (I-A) can be an organoamine group. The organoamine group can be derived from an organoamine source utilized during formation of the carbon dioxide sorbent molecule. The organoamine group (and/or the organoamine source) can include or be derived from any suitable amine such as a primary amine, secondary amine, a tertiary amine, a polyamine, an imine, an aminocarboxamidine, a polyimine, a Schiff base, an amine capable of forming an imine, an amine capable of forming a Schiff base, or combinations thereof. Aminocarboxamidine includes guanidine. The organoamine group (and/or the organoamine source) can include or be derived from any suitable amino acid (e.g., alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and valine), or any suitable polypeptide formed from two or more amino acids.

In at least one embodiment, each of R¹, R², and R³ of Formula (I-A) can be, independently, an organoamine group represented by Formula (III-A), Formula (III-B), Formula (III-C), Formula (III-D), or Formula (III-E):

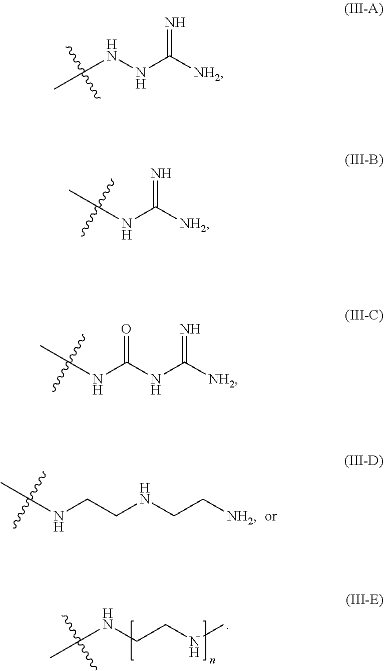

wherein the wavy bonds in Formulas (III-A)-(III-E) represent a connection to the methylene carbon positioned between an R group of Formula (I-A) and the amine NH group of Formula (I-A), or a connection to the carbon of the dimethylene ether (—CH₂—O—CH₂—) that is positioned between an R group of Formula (I-A) and the amine NH group of Formula (I-A). That is, the wavy bond represents a connection to A¹, A², and/or A³ of Formula (I-A).

As noted above, the carbon dioxide sorbent molecule can include both a methylene and a dimethylene ether connecting an R group and an amine NH group.

Formula (III-A) is an aminoguanidine group, Formula (III-B) is a guanidine group, Formula (III-C) is a guanyl urea group, Formula (III-D) is a diethylenetriamine group, and Formula (III-E) is a polyethyleneimine (PEI) group.

The organoamine groups of Formula (III-D) and (III-E) can serve to act as both a CO₂ capture moiety and a tail to promote solubility.

In Formula (III-E), n can be an integer that is from about 1 to about 500, such as from about 1 to about 250, such as from about 1 to about 25.

The organoamine group can come from an organoamine source used during formation of the carbon dioxide sorbent molecule.

In some embodiments, each of R¹, R², and R³ of Formula (I-A) can be a salt of an organoamine group. Organoamine salt groups can include a positively charged nitrogen atom and a counter anion. The counteranion of the organoamine salt group can include at least one element from Group 13-17 of the periodic table of the elements, such as halogen (F, Cl, Br, or I), O, N, P, S, B, and the like. In some examples, the salt is a chloride salt, bromide salt, phosphate salt, sulfate salt, sulfamate (SO₃NH₂) salt, bicarbonate salt, carbonate salt. In some examples, the counteranion can be selected from the group consisting of F⁻, Cl⁻, Br⁻, and I⁻, BF₄⁻, CF₃CO₂⁻, BCl₄⁻, BBr₄⁻, BI₄⁻, NO₃⁻, NO₂⁻, ClO₄⁻, IO₃⁻, ClO₃⁻, BrO₃⁻, ClO₂⁻, OCl⁻, OBr⁻, CN⁻, OCN⁻, SCN⁻, KMnO₄⁻, HSO₄⁻, HSO₃⁻, SO₃²⁻, H₂PO₄⁻, OH⁻, CH₃CO₂⁻, HCO₂⁻, HCO₃⁻, CO₃²⁻, H₃CC₆H₄SO₂⁻, F₃CSO₃⁻, CH₃SO₃⁻, C₇H₅O₂⁻, C₃H₅O₃⁻, (CH₃(CH₂)₃)₂HPO₄⁻, and (C₆H₅)₄B⁻, among others.

Illustrative, but non-limiting, examples of organoamine salt groups useful for R¹, R², or R³ of Formula (I-A) can include an aminoguanidine salt (such as an HCl salt, a phosphate salt, a sulfate salt, a bicarbonate salt, among others) or a guanidine salt (such as an HCl salt, a phosphate salt, a sulfate salt, a sulfamate salt, a carbonate salt, among others).

### I.A.2. R Groups as an Ionizable Functional Group (or a Salt Thereof)

As described above, and in some embodiments, at least one of R¹, R², and R³ of Formula (I-A) can be an ionizable functional group or a salt thereof. The ionizable functional group (or salt thereof) can help solubilize the carbon dioxide sorbent molecule.

The ionizable functional group can be present as an ion, a salt, or combinations thereof. The ionizable functional group (or salt thereof) is different from the organoamine and the melamine. The ionizable functional group or salt thereof can be derived from an ionizable functional group source or a salt source, respectively, utilized during formation of the carbon dioxide sorbent molecule.

Illustrative, but non-limiting, examples of ionizable functional groups (or salts thereof), useful for R¹, R², or R³ of Formula (I-A) can be represented by Formula (IV-A), Formula (IV-B), or combinations thereof:

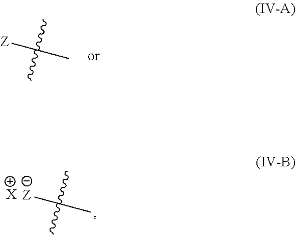

As shown, Z in Formula (IV-A) and Formula (IV-B) is an R group of Formula (I-A). In Formula (IV-A) and Formula (IV-B), the wavy bonds represent a connection to the methylene carbon positioned between an R group of Formula (I-A) (which is “Z” in IV-A/IV-B) and the amine NH group of Formula (I-A), or a connection to the carbon of the dimethylene ether (—CH₂—O—CH₂—) that is positioned between an R group of Formula (I-A) and the amine NH group of Formula (I-A). That is, the wavy bond represents a connection to A¹, A², and/or A³ of Formula (I-A).

In Formula (IV-A) and Formula (IV-B), Z is a functional group comprising at least one element from Group 13-17 of the periodic table of the elements, such as N, P, O, S, or combinations thereof. In some examples, Z comprises a sulfate, a sulfonate, a carboxylic acid, a phosphate, a phosphonate, or combinations thereof, among others. In some examples, Z comprises —SO₃H, —OSO₃H, —CO₂H, —OPO₃R*₂, —PO₃R*₂, a hydrocarbyl substituted with —SO₃H, a hydrocarbyl substituted with —OSO₃H, a hydrocarbyl substituted with —CO₂H, a hydrocarbyl substituted with —OPO₃R*₂, a hydrocarbyl substituted with —PO₃R*₂, or combinations thereof, wherein each R* is independently hydrogen, hydrocarbyl (for example, an alkyl). In some embodiments, the group represented by Formula (IV-A) or Formula (IV-B) can be in the form of an anion (for example, —SO₃⁻).

Formula (IV-B) illustrates a salt. The anion of Formula (IV-B) is represented by Z⁻. The cation (X) of Formula (IV-B) can be monoatomic or polyatomic. Monoatomic cations can include an alkali metal (for example, Li, Na, K, Rb, and Cs), an alkaline earth metal (for example, Be, Mg, Ca, Sr, and Ba), a transition metal (for example, Fe, Zn, Mn), or combinations thereof. Polyatomic cations can include such as ammonium (NR*₄⁺, wherein each R* is independently hydrogen, hydrocarbyl (for example, an alkyl), pyridinium, or combinations thereof.

The ionizable functional group can come from an ionizable functional group source used during formation of the carbon dioxide sorbent molecule. The salt of the ionizable functional group source can come from a salt source used during formation of the carbon dioxide sorbent molecule. Additionally, or alternatively, an ionizable functional group can be made and the ionizable functional group can then be made into a salt.

In some embodiments, the carbon dioxide sorbent molecule is free of an ionizable functional group or salt group.

### I.A.3. R Groups as a Polar Non-Ionizable Functional Group

As described above, and in some embodiments, at least one of R¹, R², and R³ of Formula (I-A) can be a polar non-ionizable functional group. The polar non-ionizable functional group (or salt thereof) can help solubilize the carbon dioxide sorbent molecule.

The polar non-ionizable functional group is different from the ionizable functional group (or salt thereof), the organoamine, and the melamine. The polar non-ionizable functional group can be derived from a polar non-ionizable functional group source, utilized during formation of the carbon dioxide sorbent molecule.

Illustrative, but non-limiting, examples of polar non-ionizable functional group, useful for R¹, R², or R³ of Formula (I-A) can be represented by Formula (IV-C):

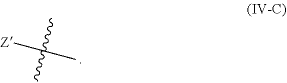

As shown, Z in Formula (IV-C) is an R group of Formula (I-A).

In Formula (IV-C), the wavy bonds represent a connection to the methylene carbon positioned between an R group of Formula (I-A) and the amine NH group of Formula (I-A), or a connection to the carbon of the dimethylene ether (—CH₂—O—CH₂—) that is positioned between an R group of Formula (I-A) and the amine NH group of Formula (I-A). That is, the wavy bond represents a connection to A¹, A², and/or A³ of Formula (I-A).

In Formula (IV-C), Z′ is a functional group comprising at least one element from Group 13-17 of the periodic table of the elements, such as halogen (e.g., F, Cl, Br, or I), N, P, O, S, or combinations thereof. In some examples, Z′ comprises a hydroxyl (—OH), a ketone, an ester, an amide, a carbamate, a urethane, a halogen, or combinations thereof. Additionally, or alternatively, Z′ can include a substituted hydrocarbyl such as those substituted hydrocarbyls described above.

The polar non-ionizable functional group can come from a polar non-ionizable functional group source used during formation of the carbon dioxide sorbent molecule. In some embodiments, the carbon dioxide sorbent molecule is free of a polar non-ionizable functional group.

I.A.4. R Groups for Bonding to a Solid Support, or the Carbon Dioxide Sorbent Molecule Embedded or Dispersed within a Matrix

In some embodiments, at least one of R¹, R², or R³ of Formula (I-A) can be a functional group that can couple, bond, or otherwise attach the carbon dioxide sorbent molecule to a solid support. In such embodiments, the functional group can be a reactive functional group such as an alkene, methacrylate, hydroxymethylol, silane, aminosilane, aldehyde, or ketone, among others. Such reactive functional groups can react with reactive functional groups on the solid support. In some embodiments, at least one of R¹, R², and R³ of Formula (I-A) can represent a solid support, a solid phase, a support matrix, or combinations thereof.

The solid support, solid phase, support matrix, or combinations thereof, can include particles, beads, fibers, thin films, polymers, powders, foams, or combinations thereof, among others. In some embodiments, the carbon dioxide sorbent molecule can be chemically coupled (chemically bonded) to the solid support, solid phase, or support matrix.

Additionally, or alternatively, the carbon dioxide sorbent molecule can be physically coupled to the solid support, solid phase, or support matrix. Additionally, or alternatively, the carbon dioxide sorbent molecule can be embedded and/or dispersed within the solid support, solid phase, or support matrix.

The beads can be composed of sand, ceramic, glass, polymer, cellulosic, inorganic, organic, and/or biobased substrates, among other materials. The beads can be hollow or filled. The beads can be coated. The beads can be any suitable size. In some embodiments, the beads are coated with a carbon dioxide sorbent molecule. In at least one embodiment, the beads include reactive functional groups to chemically couple and form the carbon dioxide sorbent molecule.

The fibers can be composed of ceramic, glass, polymer, cellulosic, inorganic, organic, and/or biobased substrates, among other materials. The fibers can be coated. The fibers can have any suitable dimension or length. In some embodiments, the fibers are coated with a carbon dioxide sorbent molecule. In at least one embodiment, the fibers include reactive functional groups to chemically couple and form the carbon dioxide sorbent molecule.

Thin films that include the carbon dioxide sorbent molecule can be placed on a pliable surface or a rigid surface. Thin films that include the carbon dioxide sorbent molecule can be placed on a silicon wafer. The thin films can have any suitable dimension or length.

In some embodiments, the films can be made by utilizing a concentrated solution of carbon dioxide sorbent molecule or diluting the carbon dioxide sorbent molecule in water to form a solution, and then spray applying the solution onto a substrate. For example, a solution that includes a carbon dioxide sorbent molecule can be spin-coated and coupled onto a silicon wafer, then dried. The thin film can then be utilized to absorb CO₂. After CO₂ absorption, the thin film can be, for example, exposed to a voltage to promote desorption of CO₂.

Additionally, or alternatively, a solid-state composition can include a powder and the powder includes the carbon dioxide sorbent molecule. Here, the carbon dioxide sorbent molecule can be cured under any suitable conditions such as ambient conditions, thermal conditions, chemical conditions, coalescence conditions, or catalyzed conditions and then ground to a powder. In some embodiments, the carbon dioxide sorbent molecule can be coupled to a polymer and utilize the polymer to promote curing through heating a use of a catalyst. In some embodiments, the powder can be arranged as a sorbent media bed in, for example, a tube, film, or other bed.

Additionally, or alternatively, a solid-state composition can include a foam and the foam includes the carbon dioxide sorbent molecule. The foam can include a liquid and a dispersion of air and/or gas bubbles. The carbon dioxide sorbent molecule can be in the liquid phase of the foam, can be present within the bubbles of the foam, or combinations thereof. In some embodiments, the foam can be made by first dispersing the carbon dioxide sorbent molecule in a liquid medium. The enhanced liquid can be made into a foam containing closed and/or open cell bubbles with dimensions of the foam cells being of any suitable size such as a nanometer, micrometer, millimeter, centimeter, or combinations thereof. The foam can be cured under any suitable conditions such as ambient conditions, thermal conditions, chemical conditions, or catalyzed conditions. Here, the carbon dioxide sorbent molecule is dispersed within a matrix.

### I.A.5. Exemplary Carbon Dioxide Sorbent Molecules

Illustrative, but non-limiting, examples of the carbon dioxide sorbent molecule can include one or more of the following:

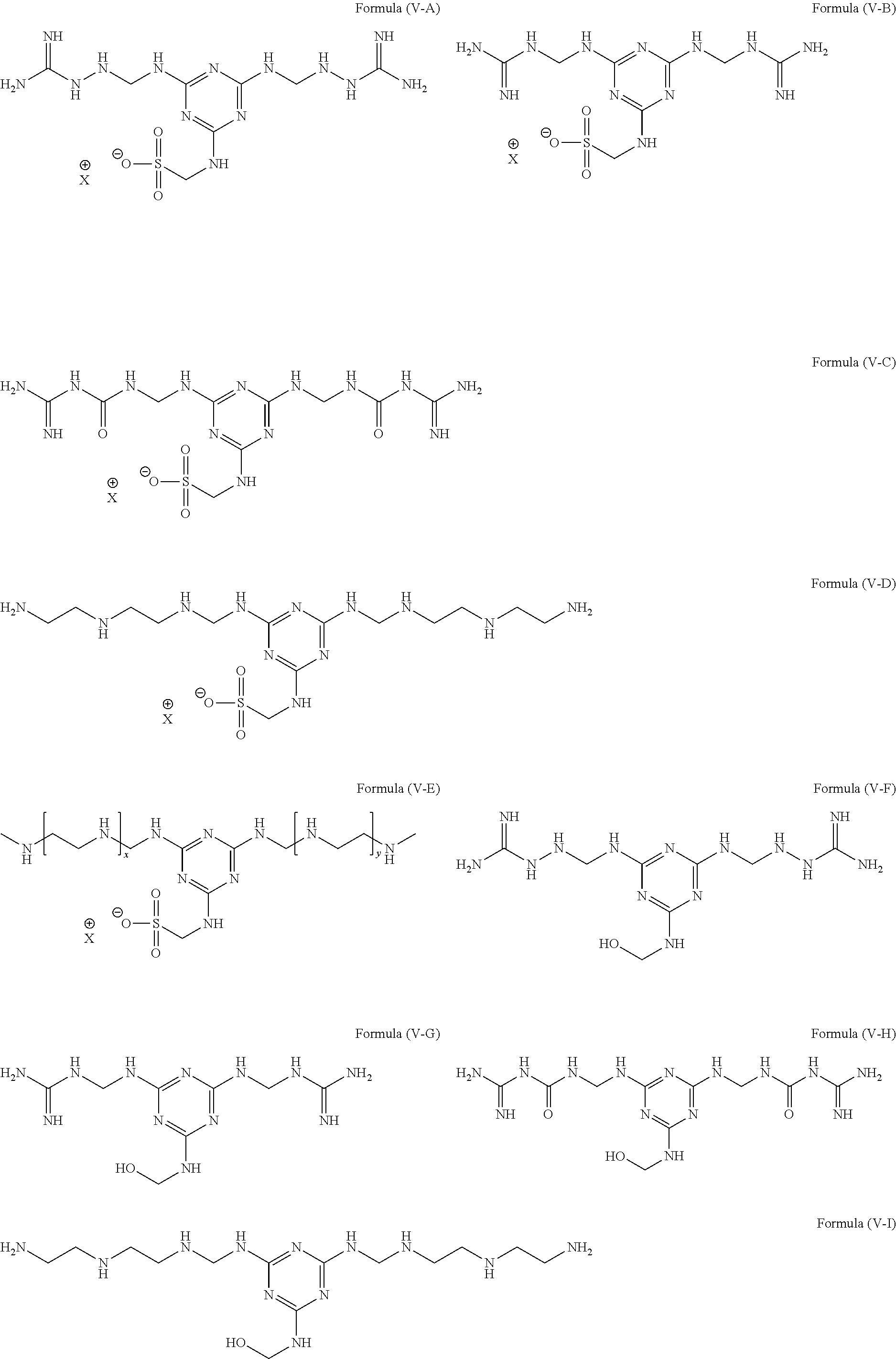

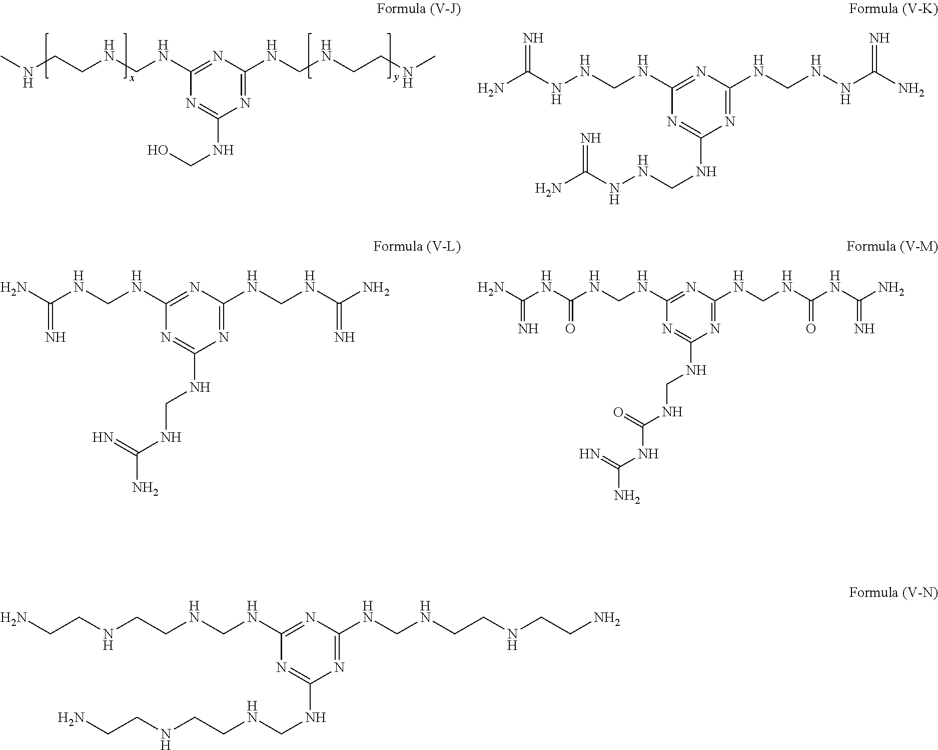

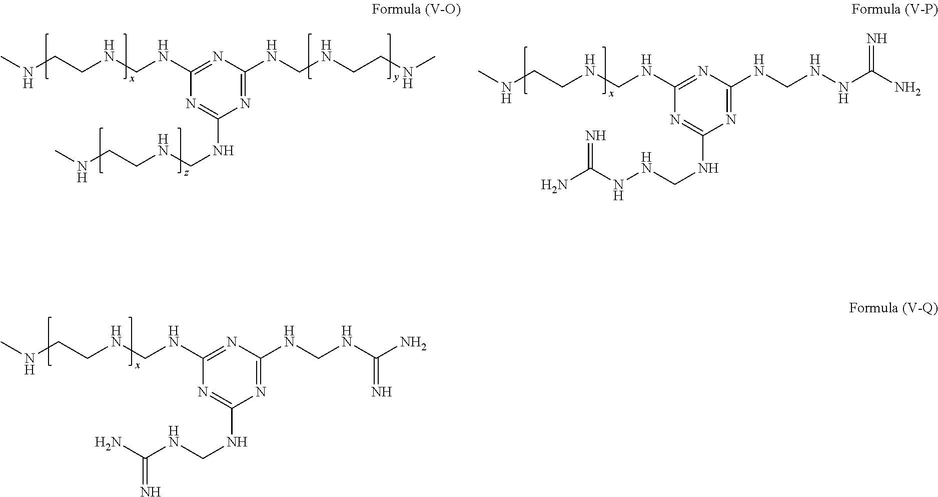

For the carbon dioxide sorbent molecules represented by Formulas (V-A)-(V-E), each X⁺ is, independently, a monoatomic cation or polyatomic cation such as those described above, for example, Na, K, pyridinium, ammonium, or alkylammonium. In Formula (V-E), Formula (V-J), Formula (V-O), Formula (V-P) and Formula (V-Q), each of x, y, and z are, independently, an integer from about 1 to about 500, such as from about 1 to about 250, such as from about 1 to about 25.

Carbon dioxide sorbent molecules represented by Formulas (V-A)-(V-E) are bis-functionalized carbon dioxide sorbent molecules connected through a melamine-formaldehyde. Formulas (V-A)-(V-E) are reaction products (or adducts) of a melamine-formaldehyde reaction product (or adduct) with an aminoguanidine (as shown by the bis-aminoguanidine of Formula (V-A)), a guanidine (as shown by the bis-guanidine of Formula (V-B)), a guanyl urea (as shown by the bis-guanyl urea of Formula (V-C)), a diethylenetriamine (as shown by the bis-diethylenetriamine of Formula (V-D)), or a polyethyleneimine (as shown by the bis-PEI of Formula (V-E)), respectively.

Carbon dioxide sorbent molecules represented by Formulas (V-K)-(V-O) are tris-functionalized carbon dioxide sorbent molecules connected through a melamine-formaldehyde. Formulas (V-K)-(V-O) are reaction products (or adducts) of a melamine-formaldehyde reaction product (or adduct) with an aminoguanidine (as shown by the tris-aminoguanidine of Formula (V-K)), a guanidine (as shown by the tris-guanidine of Formula (V-L)), a guanyl urea (as shown by the tris-guanyl urea of Formula (V-M)), a diethylenetriamine (as shown by the tris-diethylenetriamine of Formula (V-N)), or a polyethyleneimine (as shown by the tris-PEI of Formula (V-O)), respectively.

Carbon dioxide sorbent molecules represented by Formulas (V-P) and (V-Q) are tris-functionalized carbon dioxide sorbent molecules connected through a melamine-formaldehyde. Formula (V-P) is a reaction product (or adduct) of a melamine-formaldehyde reaction product (or adduct) with aminoguanidine and PEI. Formula (V-Q) is a reaction product (or adduct) of a melamine-formaldehyde reaction product (or adduct) with guanidine and PEI.

In some embodiments, carbon dioxide sorbent molecules represented by Formula (I-A) can be used for solid-state sequestration of CO₂.

Various other carbon dioxide sorbent molecules are also contemplated. Some of these carbon dioxide sorbent molecules are described elsewhere herein, for example, below in the “Variations” of the synthesis.

### I.B. Optional Components of the Composition

As described above, compositions of the present disclosure (e.g., compositions for absorbing CO₂, desorbing CO₂, or both) can include one or more optional components. The one or more optional components can include a solvent, an additive, or combinations thereof.

The solvent useful for compositions described herein can include an aqueous solvent, an organic solvent, or combinations thereof. Aqueous solvents can be selected from the group consisting of water, distilled water, deionized water, ultra-pure water, and combinations thereof. Organic solvents can be selected from the group consisting of halogenated solvents, alcohol solvents, alkylcarbonate solvents, ketone solvents, hydrocarbon solvents, ester solvents, ether solvents, and combinations thereof. Halogenated solvents can be selected from the group consisting of dichloromethane, chloroform, and combinations thereof. Alcohol solvents can be selected from the group consisting of ethanol (EtOH), methanol, isopropanol, n-propanol, n-butanol, isobutanol, sec-butanol, an amyl alcohol (such as n-pentanol, isopentanol, and sec-pentanol), and combinations thereof. Alkylcarbonate solvents can be selected from the group consisting of dimethyl carbonate, diethyl carbonate, dipropyl carbonate, and combinations thereof. Ketone solvents can include acetone. Hydrocarbon solvents can be selected from the group consisting of hexane, pentane, cyclohexane, benzene, toluene, and combinations thereof. Ester solvents can include ethyl acetate. Ether solvents can be selected from the group consisting of dimethyl ether, diethyl ether, tetrahydrofuran, dipropylene glycol dimethyl ether, methyl tert-butyl ether, glycol ether, and combinations. Other solvents such as dimethylformamide, acetonitrile, N-methyl-2-pyrrolidone, dimethyl sulfoxide, or combinations thereof can be utilized.

In some examples, the solvent comprises, consists essentially of, or consists of an aqueous solvent.

Mixtures of aqueous solvents and mixtures of organic solvents can be utilized. A mixture of one or more aqueous solvents and one or more organic solvents can be utilized. It is contemplated that the aqueous solvent or organic solvent can, instead, be used as an additive. For example, a relatively small amount of aqueous solvent relative to the organic solvent can be utilized. As another example, a relatively small amount of organic solvent relative to the aqueous solvent can be utilized.

Compositions described herein may further include additives. Additives can be utilized to, for example, enhance efficiency of the composition to absorb or capture CO₂, increase capacity of the composition to absorb or capture CO₂, increase the speed at which the composition absorbs or captures CO₂, or combinations thereof. Efficiency can be enhanced by adjusting the pH of the composition.

Illustrative, but non-limiting, examples of additives can include cyanuric acid, glycine, amino acids, diethylenetriamine (DETA), monoethanolamine (MEA), diethanolamine (DEA), 2-(diethylamino)ethanol (DEEA), N,N-dimethyl-cyclohexylamine (DMCA), 1,4-butadiamine (BDA), N-methyl-1,3-propanediamine, various liquid amines, organic solubilized amines, aqueous solubilized amines, β-amino alcohols, serinol, trishydroxyaminomethane (TRIS), metal hydroxides (for example, NaOH, KOH, Mg(OH)₂, Ca(OH)₂, Al(OH)₂, Fe(OH)₂), soluble metal salts (for example, CuCl₂, CuSO₄, Cu(NO₃)₂, FeCl₂, FeCl₃, FeSO₄, MgCl₂, MgSO₄), biphasic solvents (such as ionic liquids and various alcohols), lipophilic amines, polyethylene amine (can be branched or linear with a weight-average molecular weight that can be from about 100 g/mol to about 100,000 g/mol, for example, PEI), amine modified cellulosic or chitin based materials, sulfolane, metal organic frameworks, or combinations thereof, among others.

Cyanuric acid can, for example, increase the capacity of the carbon dioxide sorbent molecule to bind CO₂. Glycine can, for example, increase the speed of CO₂ capture.

Metal organic frameworks (MOFs) are inorganic-organic frameworks that can, for example, increase capacity to absorb CO₂ and/or increase efficiency to absorb CO₂. MOFs include metals and organic ligands. It is contemplated that a carbon dioxide sorbent molecule described herein can be in the form of metal organic frameworks, where the carbon dioxide sorbent molecule is an organic ligand. Additionally, or alternatively, an MOF that is separate from the carbon dioxide sorbent molecule is contemplated. Here, for example, a carbon dioxide sorbent molecule such as SMFG (described in the examples) can hold about 3 moles of CO₂ per mole of sorbent before being saturated. The MOFs act like a bowl that can fill up with CO₂ but can also fill up with nitrogen (N₂) so selectivity can be an issue. This may be due to most MOFS acting as more of a mechanical or physical binder. The SMFG (or other carbon dioxide sorbent molecule) can help enhance selectivity and capacity if coupled with a MOF.

Mixtures of additives, in suitable proportions, can be utilized in compositions described herein.

Additionally, or alternatively, and in some embodiments, capturing or absorbing CO₂ can be enhanced by higher humidity conditions, controlled air or gas flow rates, or combinations thereof.

Compositions for absorbing CO₂, desorbing CO₂, or combinations thereof can be made by any suitable process. For example, the carbon dioxide sorbent molecule can be suitably mixed with an optional solvent, an optional additive, or combinations thereof.

### Processes for Forming Carbon Dioxide Sorbent Molecules

Embodiments of the present disclosure also generally relate to processes for forming carbon dioxide sorbent molecules. Processes for synthesizing carbon dioxide sorbent molecules can be performed in any suitable reactor.

Unlike conventional technologies, the carbon dioxide sorbent molecule can be made in an aqueous environment and in a one-pot reaction setup. The synthesis can also be free of a filtration operation. The synthesis can also be free of organic solvent, and has a lower amount of waste generated compared to current syntheses outlined in literature. It is contemplated that the product of the synthesis can be precipitated and concentrated under vacuum and then be reconstituted in water for CO₂ capture.

An illustrative, but non-limiting, reaction diagram for the synthesis of a carbon dioxide sorbent molecule is shown in Scheme 1. Scheme 1 is a non-limiting illustration of a one-pot synthesis that can be used to form a carbon dioxide sorbent molecule.

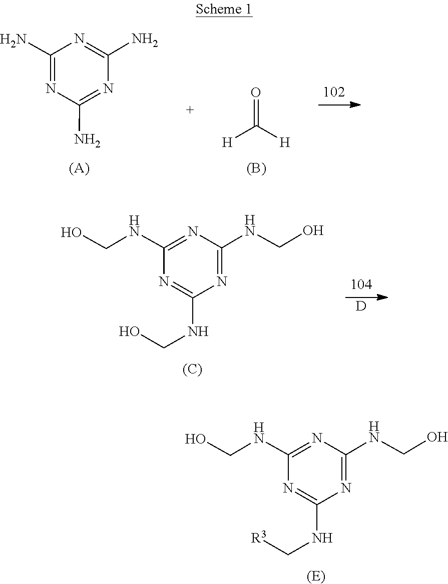

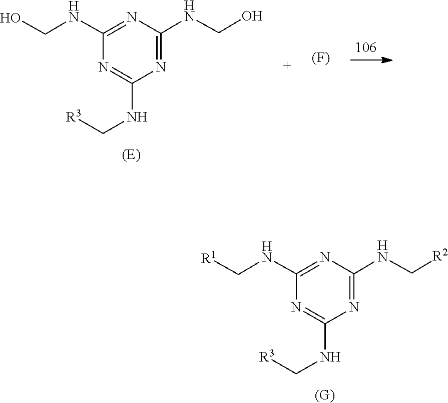

Although not shown in Scheme 1, a similar one-pot synthesis can be performed to achieve a carbon dioxide sorbent molecule where a dimethylene ether (—CH₂—O—CH₂—) bridge couples one or more of R¹, R², or R³ to the melamine NH. The synthesis can form a product mixture that includes carbon dioxide sorbent molecules having methylene bridges, dimethylene ether bridges, or combinations thereof.

In Scheme 1, (A) is melamine; (B) is a source of formaldehyde; (C) is a reaction product of melamine and formaldehyde, a melamine-formaldehyde or methylolated melamine; (D) represents a precursor material that includes an ionizable functional group or salt thereof (for example, an ionizable functional group source, a salt source, or a polar non-ionizable functional group); (E) is a reaction product of (C) and (D) such as a mono-substituted methylolated melamine; (F) represents a precursor material that includes an organoamine (for example, an organoamine source); and (G) is a non-limiting example of a carbon dioxide sorbent molecule.

In some embodiments, operation 102 of Scheme 1 includes reacting a mixture comprising melamine represented by (A), a source of formaldehyde represented by (B), and a catalyst to form a melamine-formaldehyde reaction product represented by (C). In some embodiments, a molar ratio of formaldehyde to melamine can be about 3:1. The catalyst can be a base catalyst such as NaOH. The mixture for operation 102 can further include a solvent such as water. In some embodiments, reaction conditions of operation 102 can include conducting the reaction under basic conditions (for example, setting the mixture at a pH of about 10.5 to 11) and heating the mixture at about 80° C. for about 2 hours.

Besides formaldehyde, paraformaldehyde ((CH₂O)ₙ) can be used as a source of formaldehyde. Additionally, or alternatively, formalin (an aqueous solution of formaldehyde) can be utilized as a source of formaldehyde. Other aldehydes, as well as ketones, are also contemplated.

Operation 104 of Scheme 1 can include reacting a mixture that includes the melamine formaldehyde reaction product represented by (C) and an ionizable functional group source, or a salt source, or an organoamine source (to, e.g., accomplish structures given in Formulas (V-K)-(V-Q)), to form the reaction product represented by (E). The mixture can include one or more additional components such as a solvent among other components depending on, for example, the reactants for operation 104. The solvent can be water or an organic solvent. Reaction conditions of operation 104 can depend on the ionizable functional group source, salt source, or organoamine source utilized. In some examples, the ionizable functional group source or salt source includes sodium metabisulfite (Na₂S₂O₅). When sodium metabisulfite is utilized, reaction conditions of operation 104 can include conducting the reaction under basic conditions (for example, setting the mixture at a pH of about 10.5 to 11) and heating the mixture at about 80° C. for about 1 hour. In addition, when Na₂S₂O₅ is utilized, the reaction product (E) can be represented by Formula (E-1):

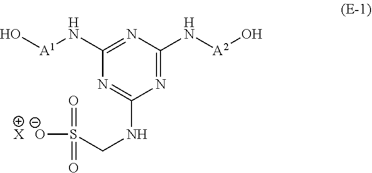

Operation 106 of Scheme 1 can include reacting a mixture that includes reaction product represented by (E) and an organoamine source represented by (F) to form the non-limiting example of a carbon dioxide sorbent molecule represented by formula (G). The mixture can include one or more additional components such as a solvent among other components depending on, for example, the reactants for operation 106. The solvent can be water or an organic solvent. Conditions and molar ratios of operation 106 can depend on the reactants utilized for operation 106. In some examples, a molar ratio of organoamine source represented by (F) to reaction product represented by (E) can be about 2:1. Various organoamine sources can be utilized depending on, for example, the desired R group. Such R groups (e.g., R¹ and R²) are described above. In some embodiments, the organoamine source can include aminoguanidine (or a salt thereof), guanidine (or a salt thereof), guanyl urea (or salt thereof), diethylenetriamine, PEI, or combinations thereof, among others. Other organoamine sources can include an amino acid (or salt thereof), a polypeptide (or salt thereof), among others.

When aminoguanidine hydrochloride (CAS No.: 1937-19-5) is utilized, reaction conditions of operation 106 can include heating the reaction mixture at about 65° C. to about 70° C. for about 1.5 hours and adjusting the pH from about 8.3 to about 7.4 during the reaction. Here, the pH can be allowed to drift during the reaction. For example, addition of aminoguanidine HCl drops the pH down to about 8.3, but as the material reacts, the pH drifts further downward throughout the reaction until a pH of about 7.4 is reached. In addition, when aminoguanidine hydrochloride is utilized as the organoamine source represented by (F), the carbon dioxide sorbent molecule represented by (G) can be represented by Formula (G-1):

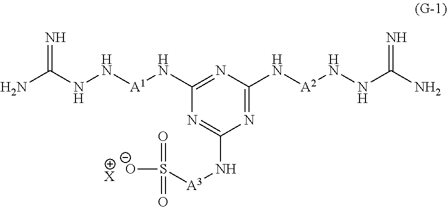

A¹, A², and A³ are described above. As shown by Formula (G-1), the aminoguanidine can be coupled by a methylene bridge (—CH₂—) to the melamine and/or can be coupled by a dimethylene ether (—CH₂—O—CH₂—) bridge to the melamine. As also shown by formula (G-1), the salt group (or an ionizable functional group or a polar non-ionizable functional group) can be coupled by a methylene bridge (—CH₂—) to the melamine or coupled by a dimethylene ether (—CH₂—O—CH₂—) bridge to the melamine.

In some embodiments, the ionizable functional group, salt thereof, or polar non-ionizable group is coupled by a methylene bridge, and the organoamine is coupled by a methylene bridge or a dimethylene ether bridge.

Several variations of the synthesis for forming carbon dioxide sorbent molecules are contemplated. The variations can be utilized to form different carbon dioxide source molecules that can be utilized in compositions for absorbing and/or desorbing CO₂. Non-limiting variations can include one or more of the following variations:

Variation 1: Operation 104 can be omitted such that the carbon dioxide sorbent molecule includes 3 organoamine groups.

Variation 2: Different organoamine sources can be utilized.

Variation 3: First reacting aminoguanidine (AG) with formaldehyde (H₂CO) at a molar ratio of about 1:1 (HCHO:AG), at a pH that is from about 10-11, and at a temperature that is from about 50° C. to about 95° C. to form a methylolated-AG reaction product. Then, charging melamine to react with the methylolated-AG at a molar ratio that is from about 1:1 to about 3:1 (methylolated-AG:melamine) at a temperature that is from about 40° C. to about 95° C. The pH can be adjusted to pH=5-10 to promote faster condensation. A solvent such as methanol, ethanol, or additional water may be added to promote solubility. Methylol sulfonation may or may not be omitted. The final pH adjustment may or may not be omitted. Other organoamine sources besides aminoguanidine (AG) source and/or combinations of organoamine sources can be utilized.

Variation 4: Melamine may be omitted to promote direct condensation of AG to AG via reaction with formaldehyde at a molar ratio of about 1:1 to about 2:1 (AG:HCHO) and at a high pH, followed by adjusting the pH lower to help facilitate condensation. Here the reaction product does not include melamine. The reaction product does include a formaldehyde source. The formaldehyde source can become a methylene bridge (—CH₂—) or a dimethylene ether (—CH₂—O—CH₂—) bridge linking the AG to the AG. The reaction product for this variation can be represented by Formula (H-1) or (H-2), respectively, with the dashed arrows pointing to the methylene bridge of Formula (H-1) and the dimethylene ether bridge of Formula (H-2):

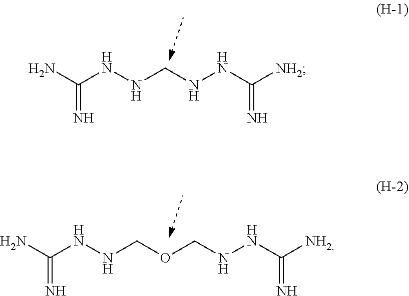 [SMILES: N=C(N)NNCNNC(=N)N ; N=C(N)NNCOCNNC(=N)N]

Other organoamine sources besides aminoguanidine (AG) source and/or combinations of organoamine sources can be utilized such that one or more different organoamine groups can be linked together by a methylene bridge or a dimethylene ether bridge.

Variation 5: Instead of the melamine-formaldehyde “core”, different mono- or multifunctional cores or core precursors can be utilized. “Ligands” can be coupled to the core. The core and ligand molecule can be represented by Formula (VI):

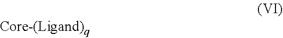

wherein: q of Formula (VI) is the number of ligands bound to the core. Here, the ligands, for example, organoamine group, ionizable functional group (or salt thereof), or polar non-ionizable functional group, or combinations thereof can be coupled to:

(a) A core that includes a polymeric amino and/or polymeric phenolic species. The organoamine group, ionizable functional group (or salt thereof), polar non-ionizable functional group, or combinations thereof can be coupled to the polymeric amino and/or polymeric phenolic species to organoamine via a mono-aldehyde, a poly-aldehyde, a mono-ketone, and/or a poly-ketone.

(b) A core that includes a partially oxidized material with varying degrees of aldehyde and/or ketone functionality. The organoamine group, ionizable functional group (or salt thereof), polar non-ionizable functional group, or combinations thereof can be coupled to the core by the aldehyde and/or ketone functionality.

(c) A core that includes a mono-carboxylic acid species and/or a poly-carboxylic acid species. The organoamine group, ionizable functional group (or salt thereof), polar non-ionizable functional group, or combinations thereof can be coupled to the core by condensation of the amine with mono or polycarboxylic acid species through the elimination of water.

(d) A core that includes a mono-halogenated species and/or poly-halogenated species. The organoamine group, ionizable functional group (or salt thereof), polar non-ionizable functional group, or combinations thereof can be coupled to the core by addition of the amine to the halogenated carbon active site, resulting in the elimination of the halogen.

(e) A core that includes a mono-epoxidized species poly-epoxidized species, a mono-glycidyl ether, and/or a poly-glycidyl ether. The organoamine group, ionizable functional group (or salt thereof), polar non-ionizable functional group, or combinations thereof can be coupled to the core by reaction with an epoxide ring carbon in either Markovnikov or anti-Markovnikov addition.

(f) A core that includes a mono-isocyanate species or poly-isocyanate species. The organoamine group, ionizable functional group (or salt thereof), polar non-ionizable functional group, or combinations thereof can be coupled to the core by the isocyanate functional group generating the resulting mono or poly carbamate species.

(g) A core that includes a mono alkyl-carbonate species, poly alkyl-carbonate species, and/or poly-cyclic carbonate species. The organoamine group, ionizable functional group (or salt thereof), polar non-ionizable functional group, or combinations thereof can be coupled to the core by, for example, via a bis-(dialkyl carbonate) route. This reaction may also be understood as a modified transurethanization also known as transcarbamoylation. Ultimately this can involve the nucleophilic amine reacting with the alkyl carbonate ester to generate the amide and eliminate the resulting alcohol, such as MeOH, EtOH, or phenol. This reaction can be more energetically favorable compared to direct amide synthesis of amines to carboxylic acids.

(h) A core that includes combinations of one or more of (a)-(g).

In some non-limiting examples, the “core” to which the organoamine group, ionizable functional group (or salt thereof), or combinations thereof can be coupled to can include phenol, urea, derivatives thereof, or combinations thereof. Here, depending on the starting materials, linkages between the organoamine group, ionizable functional group (or salt thereof), or combinations thereof can be methylene, dimethylene ether (—CH₂—O—CH₂—), amide, carbamate, as an R—C—N bond, or combinations thereof, among others. For example, instead of linking the organoamine group with a melamine formaldehyde, the core can include phthalic acid, isocyanate, and/or other poly-organic acids, among others.

Additional variations of the materials listed above can include linear or branched aliphatic, linear or branched cyclo-aliphatic, mono-alkenyl species or poly-alkenyl species of various substitutions, and mono-aromatic species or poly-aromatic species of various substitutions. Mixtures of these species described may exist in aqueous or solvent based environments.

It is contemplated that any suitable variation can be combined with another variation to form alternative variations as well as alternative carbon-dioxide sorbent molecules.

Various carbon-dioxide sorbent molecules and/or compositions thereof described herein, in either a solution or in a solid state, can be utilized for myriad applications including, but not limited to, direct air capture (DAC) for carbon capture storage (CCS) and/or carbon capture storage and utilization (CCSU).

Processes for Capturing CO₂ and Releasing CO₂

Embodiments of the present disclosure also generally relate to processes for capturing (absorbing) and/or releasing (desorbing) CO₂ utilizing a composition described herein. During absorption and/or desorption, one or more components of the composition can exist as ion(s). Processes for absorption and desorption can be performed in any suitable reactor.

Generally, a process for absorbing CO₂ can include introducing a gas stream or gas source comprising CO₂ with a composition described herein; and forming a CO₂-enriched composition. In some embodiments, the composition includes a solvent such as water or other suitable solvent. Additionally, or alternatively, the composition includes the carbon dioxide sorbent molecule in a solid state. Additives can form a portion of the composition if desired.

In some implementations, the CO₂-enriched composition includes CO₂ bound to the carbon dioxide sorbent molecule. In some embodiments, the CO₂ that is bound can be in the form of a carbonate (CO₃²⁻), a bicarbonate (HCO₃⁻), or combinations thereof. In at least one implementation, the CO₂ bound to the carbon dioxide sorbent molecule is in the form of a salt. The salt can include a cation comprising the carbon dioxide sorbent molecule; and an anion comprising a carbonate (CO₃²⁻), a bicarbonate (HCO₃⁻), or combinations thereof. The salt can optionally include a cation such as sodium, potassium, or ammonium, among others.

In some embodiments, a process for capturing CO₂ includes contacting a gas stream or gas source comprising CO₂ with a carbon dioxide sorbent molecule (or composition thereof), and precipitating a complex comprising CO₂ bound to the carbon dioxide sorbent molecule. In some embodiments, the composition includes a solvent such as water or other suitable solvent. Additionally, or alternatively, the composition includes the carbon dioxide sorbent molecule in a solid state. Additives can form a portion of the composition if desired.

In some implementations, the complex includes CO₂ bound to the carbon dioxide sorbent molecule. The CO₂ that is bound can be in the form of a carbonate (CO₃²⁻), a bicarbonate (HCO₃⁻), or combinations thereof. In at least one implementation, the CO₂ bound to the carbon dioxide sorbent molecule is in the form of a salt. The salt can include a cation comprising the carbon dioxide sorbent molecule; and an anion comprising a carbonate (CO₃²⁻), a bicarbonate (HCO₃⁻), or combinations thereof. The salt can optionally include a cation such as sodium, potassium, or ammonium, among others.

During an absorption operation, the carbon dioxide sorbent molecule can bind the CO₂ directly from air under ambient conditions by bubbling air through a solution that includes any suitable amount of carbon dioxide sorbent molecule. Additionally, or alternatively, ambient air may be passed over a solid state sorbent that includes a carbon dioxide sorbent molecule under ambient air conditions. Conditions for absorption can include ambient conditions or elevated temperature conditions such as a temperature of less than about 120° C., such as less than about 110° C. Conditions for absorption can optionally include a high humidity environment.

In some implementations of processes for absorbing CO₂, the carbon dioxide sorbent molecule can be utilized in a flue gas environment.

The CO₂ that is absorbed, captured, sequestered, or the like by processes described herein can be bonded to the carbon dioxide sorbent molecule by any suitable manner, such as by physical bonding, chemical bonding, or combinations thereof. In some examples, the absorbed, captured, or sequestered CO₂ may exist in various forms. In some implementations, the bound CO₂ may be in the form of a carbonate (CO₃²⁻), bicarbonate (CO₃²⁻), or combinations thereof. Here, and in some examples, and after exposure of the carbon dioxide sorbent molecule to CO₂, a complex can be formed that includes the carbon dioxide sorbent molecule and the CO₂, where the complex can include a carbonate and/or bicarbonate anion (from the CO₂) and a cation of the carbon dioxide sorbent molecule. Additionally, or alternatively, and in some examples, the complex can include a carbonate and/or bicarbonate anion (from the CO₂) and a cation of the carbon dioxide sorbent molecule and a monovalent cation such as sodium, potassium, or ammonium, among others. The complex can be a salt.

Additionally, or alternatively, carbon dioxide can make a chemical bond with the carbon dioxide sorbent molecule. Such chemical bonds can include a carbamate (urethane) bond depending on, for example, the capture conditions. Additionally, or alternatively, the carbon dioxide can make a physical bond with the carbon dioxide sorbent molecule, such as by electrostatic interactions such as Van der Waals forces

The CO₂ that is sequestered by one or more components of a composition described herein can be in the form of carbonate (CO₃²⁻) salt, bicarbonate (HCO₃⁻) salt, a reaction product with one or more components of the composition (e.g., a urethane), or a physically bound CO₂ by electrostatic interactions, for example, Van der Waals forces, or combinations thereof.

After capture of the CO₂ by processes described herein, the CO₂ can be desorbed or released. In some embodiments, the CO₂-enriched composition or the complex comprising the CO₂ bound to the carbon dioxide sorbent molecule can be subjected to desorption conditions to remove the CO₂ and regenerate the carbon dioxide sorbent molecule. Desorption conditions can include heat, acidic conditions, basic conditions, hydrolysis, electrolysis, electromagnetic radiation, ionic exchange, elevated pressure, vacuum pressure, or combinations thereof. In at least one embodiment, desorption conditions heat, vacuum pressure, or combinations thereof. Desorption of CO₂ from the CO₂-enriched composition or the complex comprising the CO₂ bound to the carbon dioxide sorbent molecule can form a CO₂-depleted composition.

In contrast to conventional technologies such as metal hydroxides, desorption can occur under low-temperature desorption such as from about 30° C. to about 250° C., 50° C. to about 225° C., such as from about 75° C. to about 200° C., such as from about 100° C. to about 175° C., such as from about 110° C. to about 160° C., such as less than about 160° C., or from about 120° C. to about 130° C., or from about 100° C. to about 120° C., such as about 105° C., or from about 40° C. to about 160° C., though other values are contemplated. Any of the foregoing numbers can be used singly to describe an open-ended range or in combination to describe a close-ended range

In addition, embodiments described herein can enable low-temperature desorption, such as less than about 160° C. In some non-limiting examples, desorption can be performed at a temperature of about 105° C. In other non-limiting examples, desorption temperatures can range from about 120° C. to about 130° C.

In some implementations, the CO₂ removed can be quarantined for storage, converted into a chemical substance or feedstock, or combinations thereof, among other uses. Applications and uses are further described below.

Embodiments of the present disclosure also generally relate to applications or uses of embodiments. For example, carbon-dioxide sorbent molecules and/or compositions thereof described herein, in either a solution or in a solid state, can be utilized for carbon capture storage (CCS) and/or carbon capture storage and utilization (CCSU).

Illustrative, but non-limiting, applications or uses include: direct air capture; CO₂ capture from flue gas emissions; desorbing CO₂ and then reacting with a solution of calcium hydroxide to make calcium carbonate (CaCO₃) for carbon capture storage (CCS); enhanced oil recovery (EOR) for CCSU; desorbing and concentrating CO₂ to react with a metal catalyst for methanol production which can be utilized to make formaldehyde useful for various technologies such as adhesives (CCSU); desorbing and concentrating CO₂ to synthesize alkyl carbonates which may be used in polyurethane technologies (CCSU); use as a fire retardant or fire retardant additive (CCSU); use as an agricultural amendment as either gaseous CO₂ or soil additive (CCSU); or use as a concrete additive to prevent the release of CO₂ during curing (CCS). Other applications are contemplated.

Embodiments described herein have various advantages. Unlike conventional technologies, carbon dioxide sorbent molecules described herein can be synthesized in an aqueous environment and in a one-pot reaction setup. The synthesis can also be free of a filtration operation. The synthesis can also be free of organic solvent, and has a lower amount of waste generated compared to current syntheses outlined in literature. In some embodiments, the product of the synthesis can be precipitated and concentrated under vacuum to yield a 100% solids and then be reconstituted in water.

In addition, carbon dioxide sorbent molecules described herein can be capable of desorbing CO₂ at relatively low temperatures compared to some materials currently on the market (for example, metal hydroxide scavengers such as NaOH and KOH). In contrast to carbon dioxide sorbent molecules described herein, these metal hydroxide scavengers require large investments in energy to fully boil off water and then require temperatures in the range of 900° C. to 1,000° C. to desorb the CO₂.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### EXAMPLES

### Example 1: Syntheses of Carbon Dioxide Sorbent Molecule

Scheme 2 is a non-limiting one-pot synthesis that can be used to form a carbon dioxide sorbent molecule. In this non-limiting example, the carbon dioxide sorbent molecule is a reaction product of aminoguanidine with a melamine-formaldehyde adduct.

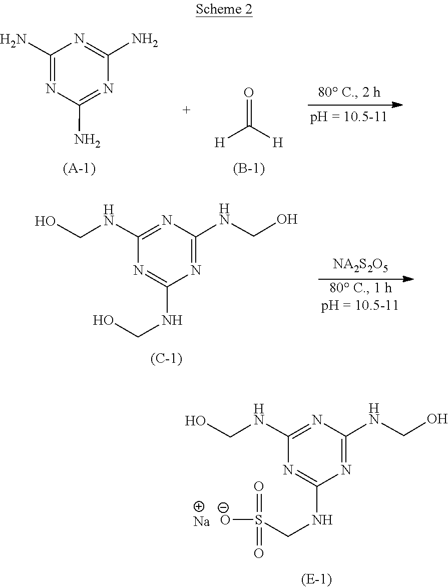

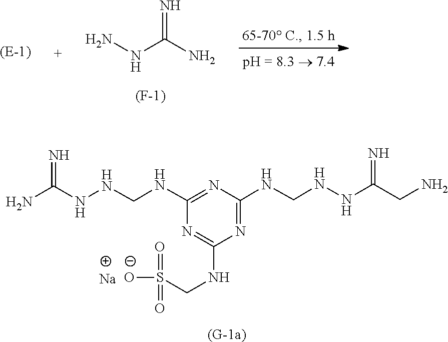

Here, a mixture that includes melamine (A-1), formaldehyde (B-1), and NaOH was reacted at a temperature of 80° C. for 2 hours to form melamine-formaldehyde adduct or reaction product (C-1). This operation is an example of operation 102. The reaction was performed at a pH of 10.5-11 with a molar ratio of formaldehyde to melamine of 3:1.

A mixture that includes melamine-formaldehyde adduct or reaction product (C-1) and sodium metabisulfite (Na₂S₂O₅) was reacted at 80° C. for 1 hour to form monosubstituted melamine-formaldehyde reaction product (E-1). This operation is an example of operation 104. Na₂S₂O₅ is an example of an ionizable functional group source or a salt source. Use of Na₂S₂O₅ can help maintain the pH range without causing decomposition of the melamine-formaldehyde adduct.

A mixture that includes monosubstituted melamine-formaldehyde reaction product (E-1) and aminoguanidine (F-1) was reacted at a temperature from 65° C. to 70° C. for 1.5 hours to form a product mixture comprising an example carbon dioxide sorbent molecule (G-1a). This operation is an example of operation 106. Aminoguanidine is an example of an organoamine source. For the reaction, aminoguanidine hydrochloride salt (aminoguanidine-HCl) was utilized. A molar ratio of aminoguanidine to substituted melamine-formaldehyde reaction product was 2:1. During the reaction, the pH was allowed to drift from 8.3 to 7.4 to aid the reaction.

It was found that the product mixture comprising the example carbon dioxide sorbent molecule (G-1a) can also include example carbon dioxide sorbent molecule (G-1b), example carbon dioxide sorbent molecule (G-1c), an ion thereof, or combinations thereof:

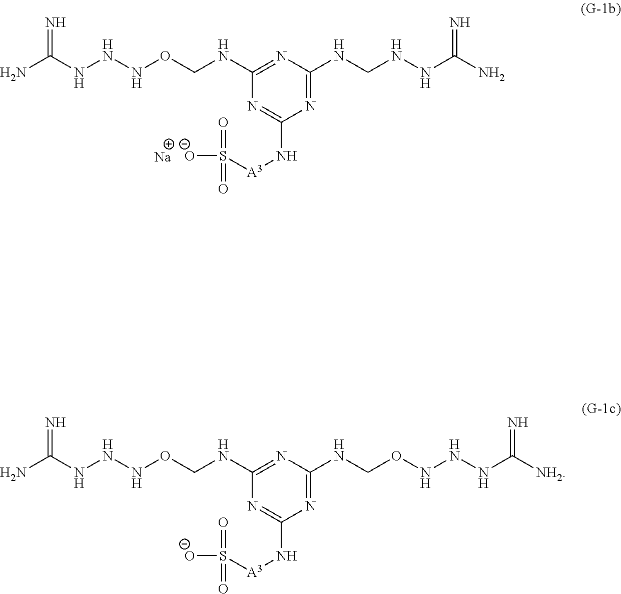

Therefore, and in some examples, the example carbon dioxide sorbent molecule (sulfonated melamine-formaldehyde-aminoguanidine (SMFG)) includes one or more of G-1a, G-1b, G-1c, or an ion thereof, as represented by:

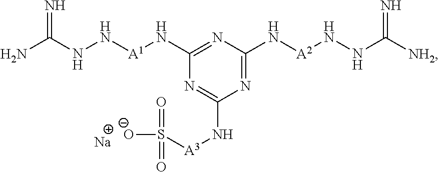

wherein: A¹ is CH₂ or CH₂OCH₂; and A² is CH₂ or CH₂OCH₂.

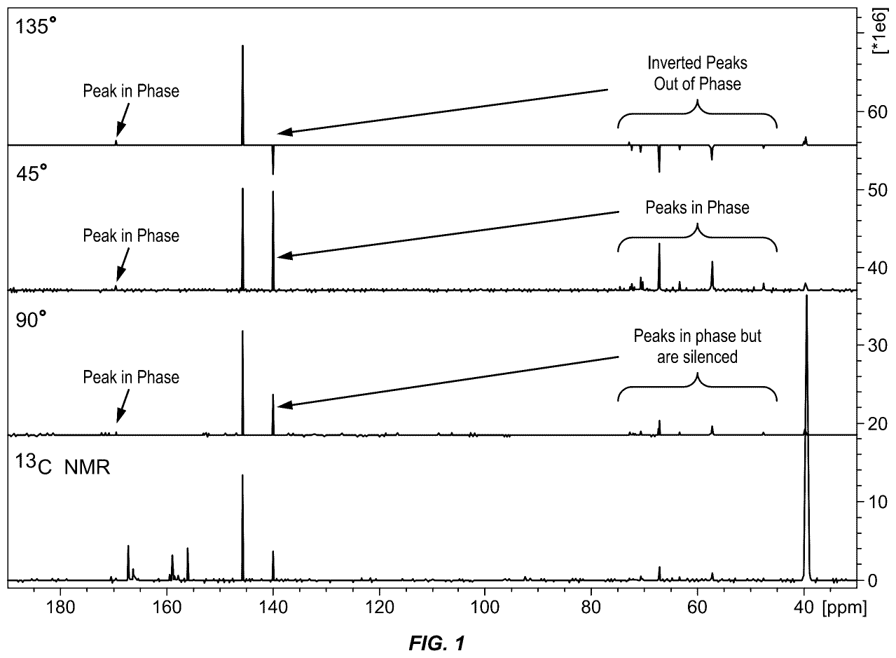

FIG. 1 shows a DEPT-¹³CNMR of the product SMFG. DEPT-¹³CNMR experiments were performed on the final product to help elucidate the structural identity of the SMFG adduct. The sample was pulsed at 45°, 90°, and 135°. As seen in the 135° pulse sequence, nearly every carbon shift was out of phase generating a negative peak. The pulse sequence at 450 resulted in chemical shifts that were in phase generating positive peaks, and the pulse sequence at 90° had chemical shifts that were in phase but significantly dampened. The chemical shifts between −45 ppm and ˜140 ppm should have disappeared in the 90° spectrum. The reason they did not disappear completely may be due to the instrument tuning. The collective spectra indicated that the linkages can contain methylene carbons (—CH₂—) and according to literature appear to align with dimethylene ether linkages (—CH₂—O—CH₂—) in the range of −60-75 ppm, although true methylene linkages (—CH₂—) are observable in the 40-60 ppm range. With respect to the product SMFG shown in the bottom panel of FIG. 1, chemical shifts were assigned as follows: D₆-DMSO (˜40 ppm); sulfonated methylol (˜56 ppm); bicarbonate carbon (˜156 ppm); methylolated aminoguanidine (˜159 ppm); and reaction product of methylolated melamine (˜167 ppm).

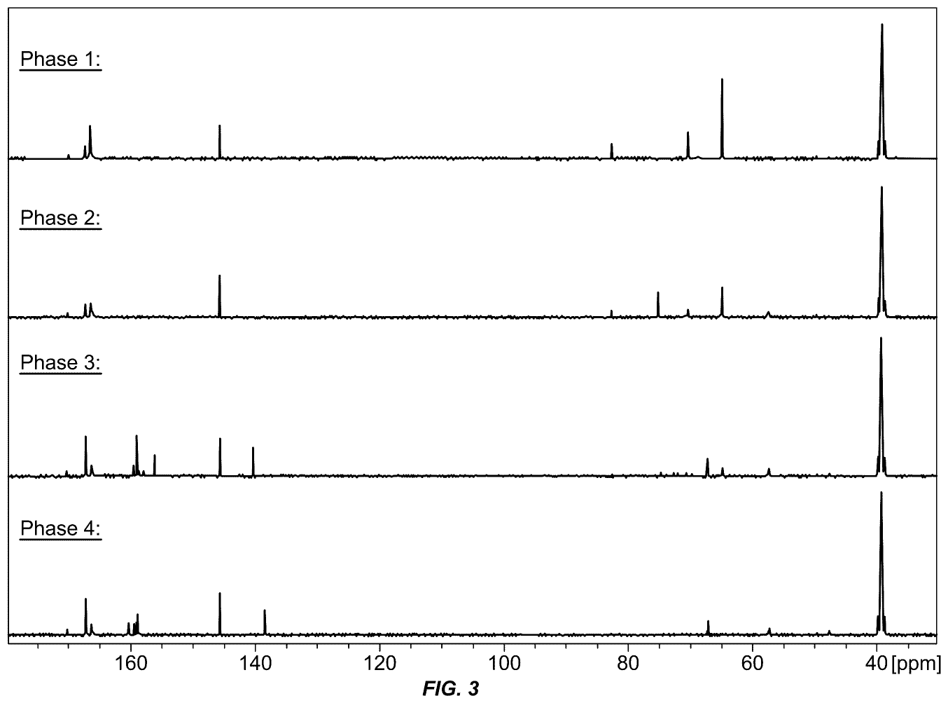

The chemical shift at ˜140 ppm appears after aminoguanidine is added and after the synthesis is complete. Here, this peak initially appears in Phase 3 at ˜140 ppm after aminoguanidine (see discussion of FIG. 3) and then shifts to ˜138 ppm at Phase 4. D₆-DMSO has chemical shifts at ˜40 ppm and internal standard (pyrazine) has a chemical shift at ˜145 ppm.

Another example carbon dioxide sorbent molecule, melamine-formaldehyde-guanidine (MFG), was synthesized in a similar manner. No sulfonation was performed and guanidine was used as the organoamine. The organoamine source can be guanidine carbonate salt (guanidine-CO₃²⁻ salt) and/or guanidine hydrochloride salt (guanidine-HCl). MFG is represented by G-2:

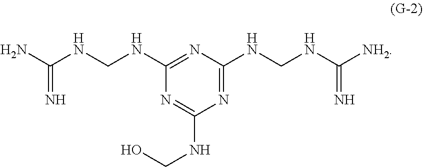 [SMILES: N=C(N)NCNc1nc(NCO)nc(NCNC(=N)N)n1]

The product mixture comprising the example carbon dioxide sorbent molecule (G-2) can also include carbon dioxide sorbent molecules having methylene bridges, dimethylene ether bridges, or combinations thereof.

The active molecules (the example carbon dioxide sorbent molecules) may be used to bind CO₂ directly from air under ambient conditions by bubbling air through an activated solution of variable concentration. Additionally ambient air may be passed over a solid state sorbent under ambient or extreme conditions with temperatures of less than about 110° C. in the presence of high humidity environments. The material may also be used in a flue gas environment.

### Example 2: CO₂ Absorption and CO₂ Desorption

### 2.A. SMFG Carbon Dioxide Sorbent Molecule

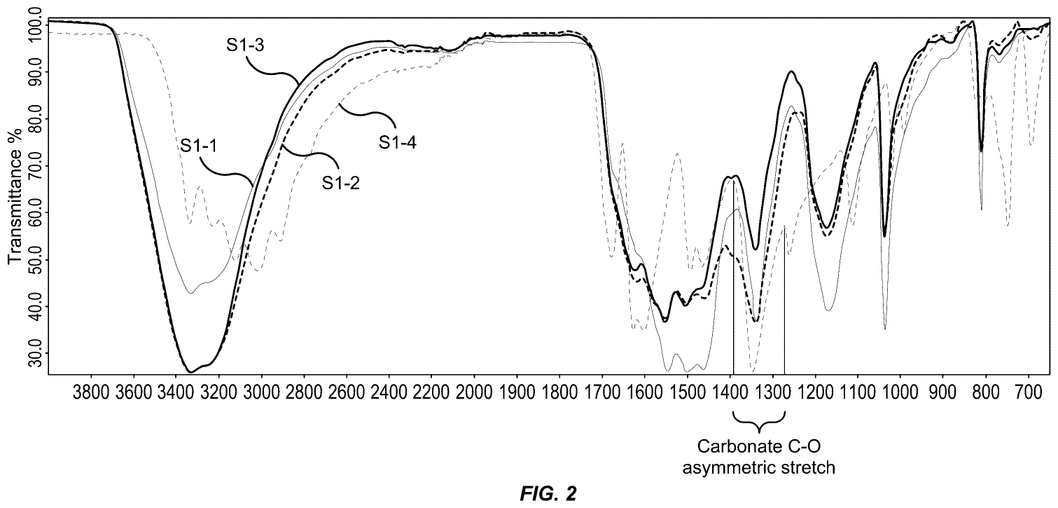

FIG. 2 is an overlay of Fourier transfer mid-infrared (FT-MIR) spectra showing CO₂ absorption by SMFG. The spectra are normalized and baseline-corrected. The overlay includes SMFG reaction precipitate formed at the end of the reaction (Sample Si-1), precipitate that formed from sparging CO₂ through a solution of SMFG (Sample S1-2), and a precipitate that had formed once the filtration run-off liquid came in contact with wash water (Sample S1-3). The aminoguanidine bicarbonate, commercially available from Sigma Aldrich, was used as a control (Sample S1-4). The carbonate C—O asymmetric stretch is bracketed by the lines at about 1270 cm⁻¹ to about 1400 cm⁻¹. The carbon dioxide sorbent molecule bound to CO₂ can exist as carbon dioxide sorbent molecule-CO₂ complex. The bound CO₂ in the complex can exist as, for example, HCO₃⁻ and/or CO₃²⁻ when bound to the aminoguanidine adduct. Overall, the results indicated that CO₂ was absorbed by SMFG as illustrated by the carbonate (C—O) stretch.

FIG. 3 is an overlay of ¹³C NMR spectra of various materials used and made during synthesis of SMFG. Various phases of the synthesis are shown in FIG. 3 including: methylolation of melamine (Phase 1); sulfonation of methylolated melamine to form sulfonated melamine-formaldehyde (SMF) (Phase 2); co-reaction of aminoguanidine-HCl with the SMF (Phase 3); and the final product SMFG at a pH of 10 (Phase 4). Chemical shift assignments of the carbon atoms (indicated by arrows) for the ¹³C NMR spectra of FIG. 3 are shown in Table 1.

TABLE 1

| | Chemical |
|---|---|
| | shift, |
| Material | ppm |
| Sodium formate | ~170 |
| Substituted and unsubstituted melamine | ~167, |
| | ~168 |
| 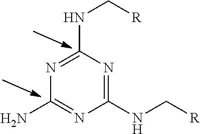 | |
| Free aminoguanidine | ~160 |
| 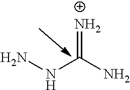 | |
| Aminoguanidine adducts | ~159 |
| 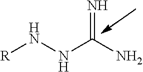 | |
| Internal standard (pyrazine) | ~146 |
| Free formaldehyde | ~82 |
| Sulfonated formaldehyde | ~75 |
| Dimethylene ether linkage | ~68-70 |
| 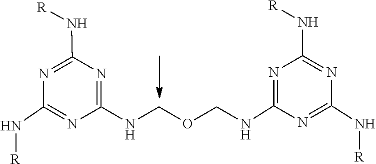 | |
| Methylol: mono-substituted | ~65-66 |
| 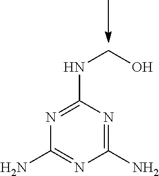 [SMILES: Nc1nc(N)nc(NCO)n1] | |
| Sulfonated melamine | ~57 |
| 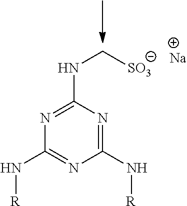 | |
| Methylene bridge adduct | ~48 |
| 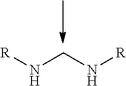 | |
| D₆-DMSO | ~40 |

With respect to the substituted and unsubstituted melamine (as well as the methylolated and sulfonated ¹³C NMR spectra), there is not a dramatic shift in the peaks at ˜167, 168 ppm. This may be due to the fact that these carbon environments (—C═N—; imine) are “locked” within the triazine ring structure and only slightly influenced by substituent(s) on the adjacent amine. These chemical shift values only correspond to the carbon in the ring and not the methylol group itself.

Overall, the ¹³C NMR data confirmed the reaction of melamine and formaldehyde to generate methylolated melamine, confirmed the sulfonation of methylolated melamine, and confirmed the reaction of aminoguanidine with SMF to form the SMFG carbon dioxide sorbent molecule.

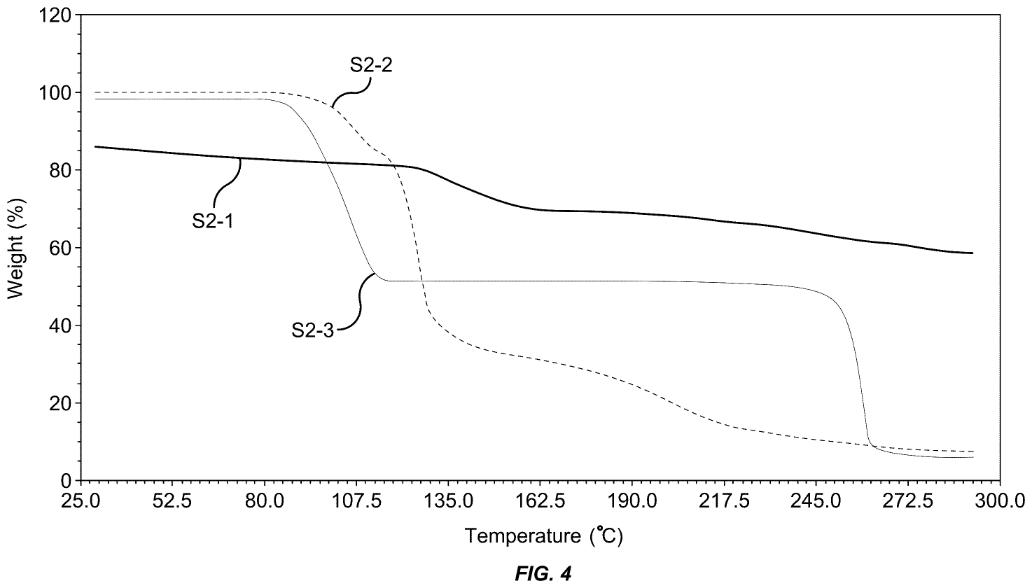

TGA was performed to characterize the CO₂ absorbed. FIG. 4 shows TGA data SMFG-CO₂ (Sample S2-1), an aminoguanidine bicarbonate (Sample S2-2) as a control, and glyoxal-bis-iminoguanidine-CO₂ (GBIG-CO₂; Sample S2-3) as a reference. For the results shown in FIG. 4, the samples were tested using a heating ramp method under atmosphere from 25° C. to 300° C. at 5° C./min. Table 2 shows percent mass loss from the TGA experiment and theoretical percent mass loss for Samples S2-1, S2-2, and S2-3. SMFG-CO₂ (Sample S2-1) had an unknown hydration state. GBIG-CO₂ (Sample S2-3) had a hydration state of 4 as GBIG-CO₂·4H₂O.

TABLE 2

| | | Mass loss, | Mass loss |
|---|---|---|---|
| Sample | Material | % | (theoretical), % |
| S2-1 | SMFG-CO₂ | 12.16 | — |
| S2-2 | Aminoguanidine bicarbonate | 67.97 | 67.67 |
| | control | | |
| S2-3 | GBIG-CO₂ | 46.87 | 48.47 |

Overall, the results shown in FIG. 4 and Table 2 indicated that CO₂ absorbed to the example carbon dioxide sorbent molecule. When comparing % mass loss in SMFG to aminoguanidine bicarbonate control and GBIG reference, the molecular weight should be taken into account. SMFG has a higher molecular weight than both GBIG and aminoguanidine bicarbonate, resulting in an overall lower mass loss as CO₂ is evolved. The data may also indicate that there is decomposition of the aminoguanidine bicarbonate control and GBIG reference. Here, the reference material GBIG appears to decompose at about 245° C., and aminoguanidine bicarbonate appears to decompose at about 200° C. Melamine itself begins to decompose at about 300° C. Although it is difficult to characterize the decomposition of SMFG because the TGA shows a very gradual downward slope, the decomposition of SMFG likely occurs at about 245° C. In any case, the decomposition temperature of SMFG (likely about 245° C.) is above the desorption temperature.

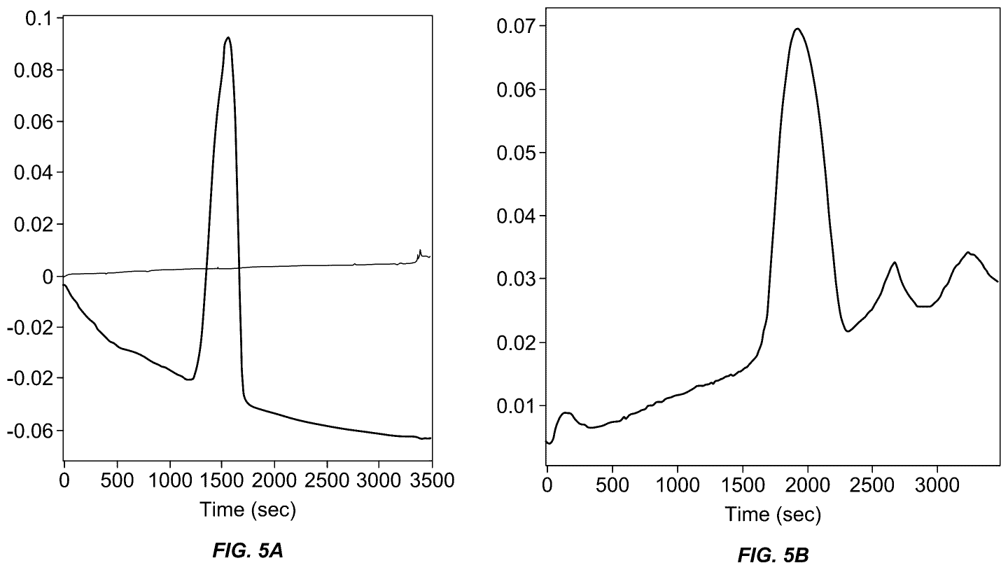

FIGS. 5A and 5B show data for evolved gas analysis of GBIG-CO₂ and SMFG-CO₂, respectively. Carbon dioxide was desorbed from SMFG-CO₂ using a heating ramp method under atmosphere from 25° C. to 300° C. at 5° C./min. The evolved gas was then passed through an FT-IR to detect the presence of CO₂. FIG. 5B indicates that CO₂ has been thermally desorbed from the newly synthesized SMFG molecule. The newly synthesized SMFG material displays CO₂ evolution of an improved magnitude when compared to GBIG. Overall, the results indicated that CO₂ can be desorbed from the SMFG-CO₂ complex.

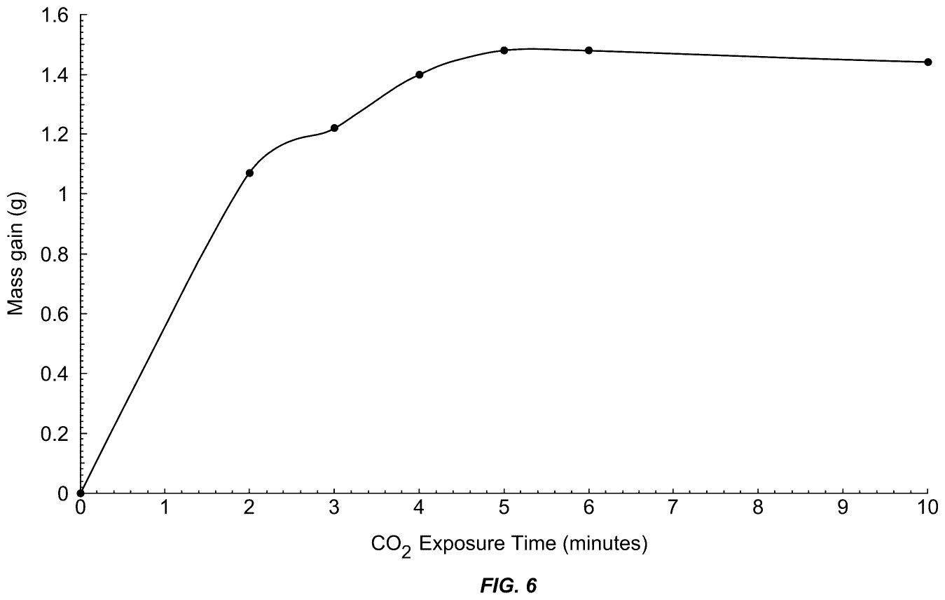

FIG. 6 shows data for mass gain as a function of CO₂ absorption time for an example carbon dioxide sorbent molecule according to at least one embodiment of the present disclosure. For the data shown in FIG. 6, the following experiment was performed: 42.16 g of a 9.98% solution of SMFG was transferred to an impinger tube and CO₂ gas was purged through a porous glass air stone. The CO₂ gas reacted with SMFG to form a precipitate in 30 seconds. Table 3 shows selected data for the experiment.

TABLE 3

| Exposure time to CO₂, | Total mass gained during exposure to CO₂, |
|---|---|
| minutes | grams |
| 0 | 0 |
| 2 | 1.07 |
| 3 | 1.22 |
| 4 | 1.4 |
| 5 | 1.48 |
| 6 | 1.48 |
| 10 | 1.44 |

As shown in FIG. 6 and Table 3, the mass gained by SMFG was about 1.48 grams after about 5 minutes of exposure to CO₂ gas. This result correlates to about 0.35 grams CO₂ per 1 gram SMFG sorbent and about 3.3 moles CO₂ per 1 mole of SMFG sorbent. The theoretical molecular weight of the SMFG sorbent was calculated to be about 414.38 g/mol. The result shown in FIG. 6 also indicated the excellent efficiency of the SMFG sorbent. The decrease in mass gained was likely due to evaporation of water.

### 2.B. MFG Carbon Dioxide Sorbent Molecule

Guanidine derivative (MFG, G-2, 4.7 wt %) was utilized for this example. Prior to exposure to CO₂, the solution was clear in appearance. Following exposure to CO₂, the solution became cloudy in appearance, indicating precipitation and that CO₂ was bound to the sorbent MFG.

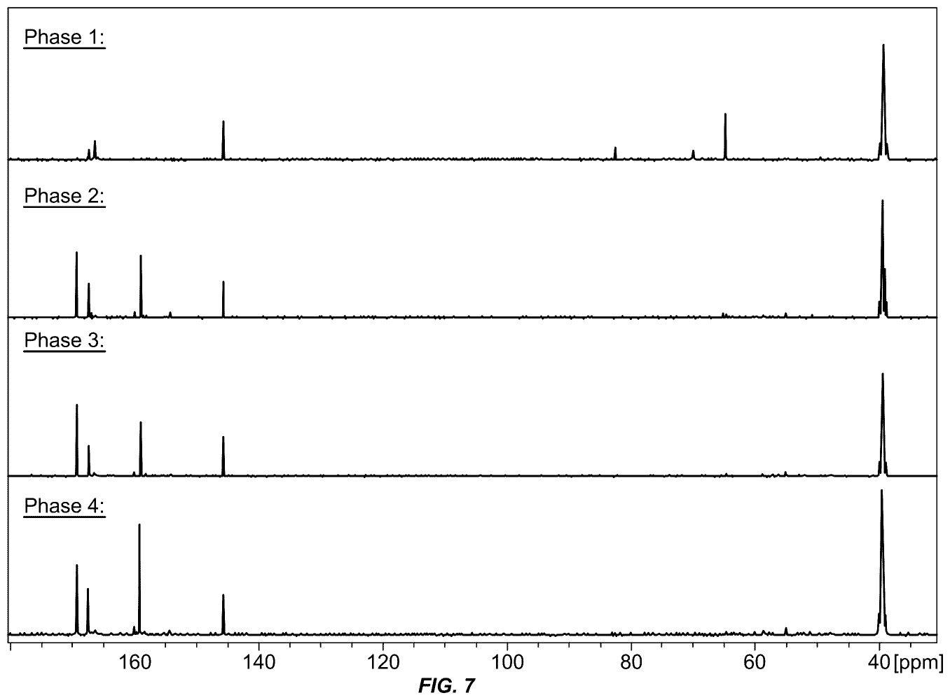

FIG. 7 is an overlay of ¹³C NMR spectra of various materials used and made during synthesis of MFG (G-2). Various phases of the synthesis are shown including: the methylolation stage that includes methylolation of melamine (Phase 1); co-reaction of guanidine-CO₃²⁻ salt with methylolated melamine, t=0 hr (Phase 2); co-reaction of guanidine-HCl salt with methylolated melamine, t=2 hr (Phase 3); and the final product MFG after distillation (Phase 4). The Phase 2 spectrum displays t=0 hr for reaction of guanidine bicarbonate with methylolated melamine. The carbonate was acidified with an excess of formic acid to decompose the carbonate to CO₂ and to adjust the pH lower to promote condensation of methylolated melamine to guanidine. Approximate chemical shifts of the carbon atoms (indicated by arrows) for the ¹³C NMR spectra of FIG. 7 are shown in Table 4.

TABLE 4

| | Chemical |
|---|---|
| | shift, |
| Material | ppm |
| Substituted and unsubstituted melamine | ~167, |
| | ~168 |
| 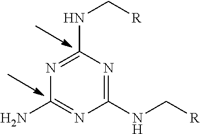 | |
| Free guanidine | ~160 |
| 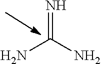 | |
| Methylolated melamine guanidine condensate | ~159 |
| 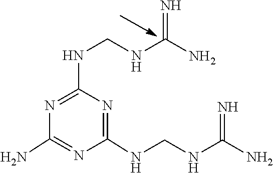 [SMILES: N=C(N)NCNc1nc(N)nc(NCNC(=N)N)n1] | |
| Internal standard (pyrazine) | ~146 |
| Free formaldehyde | ~82 |
| Dimethylene ether linkage | ~68-70 |
| 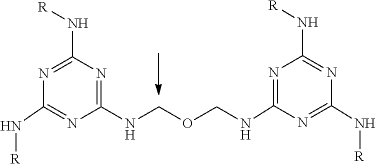 | |
| Hydroxymethyl: mono-substituted | ~65-66 |
| 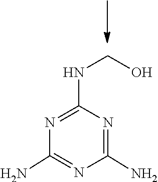 [SMILES: Nc1nc(N)nc(NCO)n1] | |
| Methylolated guanidine | ~65 |
| 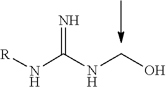 | |
| Guanidine-methylene linkage | ~55 |
| 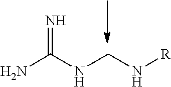 | |
| D₆-DMSO | ~40 |

Overall, the ¹³C NMR data confirmed the reaction of melamine and formaldehyde to generate methylolated melamine and confirmed the reaction of guanidine with the methylolated melamine to form the MFG carbon dioxide sorbent molecule.

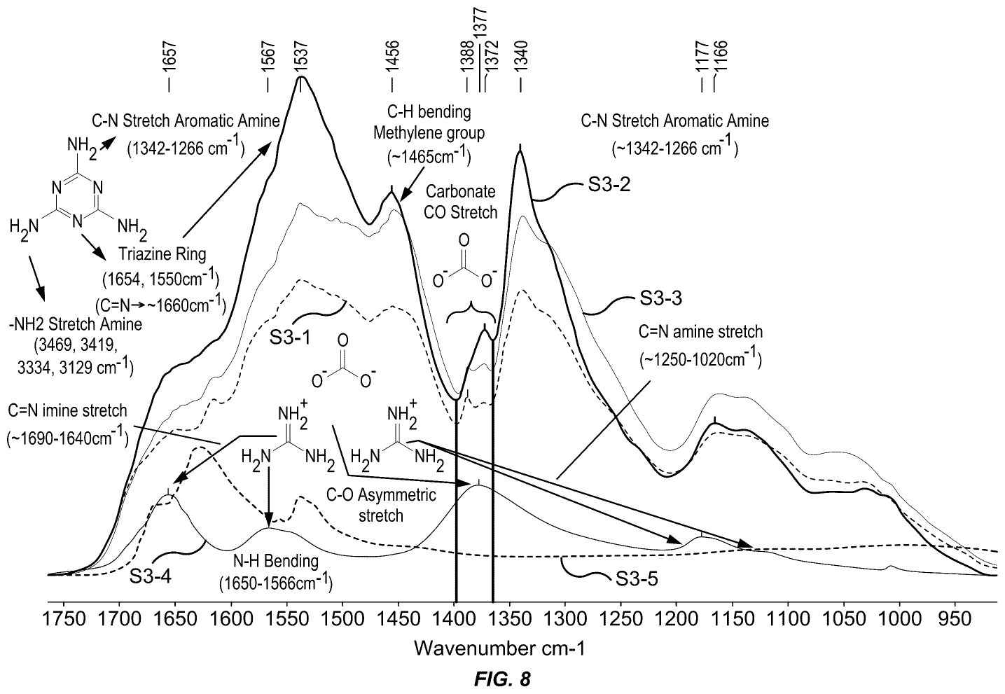

FIG. 8 is an overlay of FT-MIR spectra showing CO₂ desorption by an example carbon dioxide sorbent molecule (MFG, G-2). For this experiment, CO₂ was desorbed from the MFG-CO₂ complex at 105° C. under full vacuum. Sample S3-1 refers to MFG prior to CO₂ capture (MFG at time (t)=0 minutes), and Sample S3-2 refers to the CO₂ bound to the MFG-CO₂ complex, and Sample S3-3 refers to the resulting MFG after heating the MFG-CO₂ complex at 105° C. under full vacuum (MFG reactivated). Sample S3-4 refers to a guanidine-carbonate control which was utilized as a reference for bound CO₂. Sample S3-5 refers to a guanidine-HCl control which was utilized as a reference for no CO₂ bound. The carbonate C—O asymmetric stretch is bracketed by the lines at about 1350 cm⁻¹ to about 1400 cm⁻¹.

At a time of 0 minutes, the MFG had not been exposed to the CO₂ (Sample S3-1). Upon exposure to CO₂, an MFG-CO₂ complex was formed (Sample S3-2). Following thermal desorption, the MFG was regenerated (Sample S3-3). Overall, the results indicated that CO₂ can be absorbed by carbon dioxide sorbent molecules described herein. The results also indicated that carbon dioxide sorbent molecules described herein can be regenerated by subjecting a complex that includes CO₂ bound to the carbon dioxide sorbent molecule to desorption conditions. As shown, the desorption conditions can be mild and performed at low temperatures. Overall, carbon dioxide sorbent molecules described herein can be recyclable and be re-used for further capture and release of CO₂.

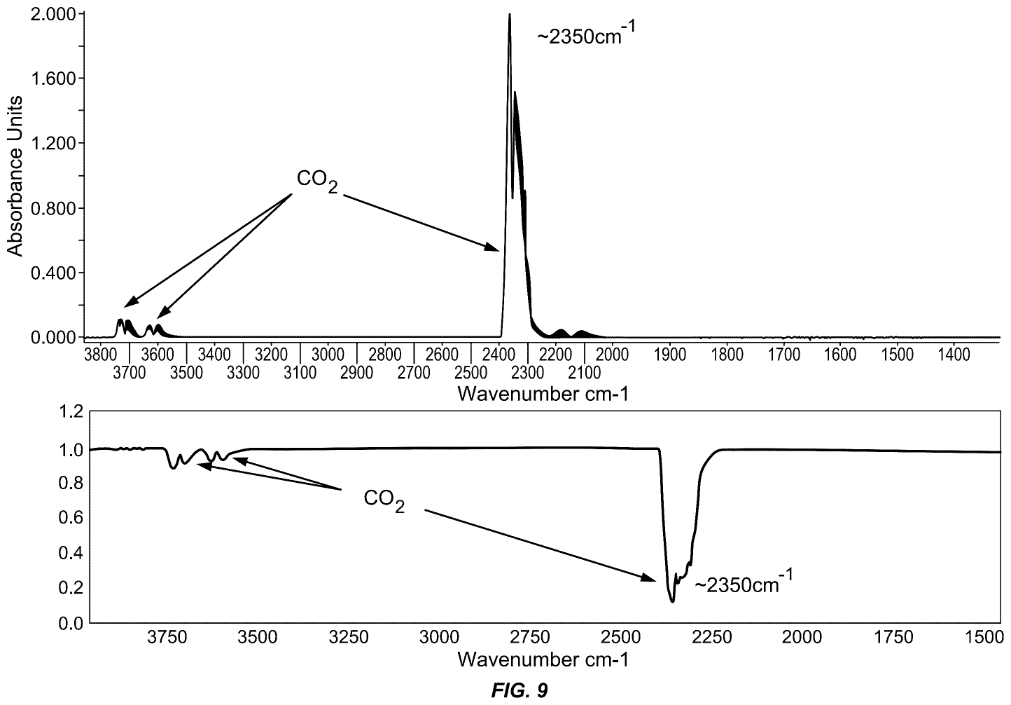

FIG. 9 shows FT-MIR spectra of carbon dioxide desorbed from the MFG-CO₂ complex (top panel) and CO₂ alone (bottom panel). For the data shown in the top panel of FIG. 9, the MFG-CO₂ complex was acidified, the headspace was sampled, and the headspace was injected into the FT-MIR. The reference FT-MIR spectrum of CO₂ (bottom panel) was obtained from the National Institute of Standards and Technology of the U.S. Department of Commerce. The spectra shown in in the top and bottom panels are not on the same scale.

Acidifying the MFG-CO₂ complex resulted in release (desorption) of the CO₂ as indicated by the absorption peak at about 2350 cm⁻¹. These results show that CO₂ can be desorbed from complexes that include CO₂ bound to carbon dioxide sorbent molecules of the present disclosure.

### Example 3. Evaluation of Carbon Dioxide Sorbent Molecules

Table 5 shows a comparison of example carbon dioxide sorbent molecules and comparative example sorbents. SMFG was made into a ˜10% solids solution (Sample S4-1) and MFG was made into a 4.7% solids solution (Sample S4-2). Comparative examples included a 0.01 M solution of 1,3,5-benzene-tri(iminoguanidine) (BTIG, Sample S4-3), a 30% monoethanolamine (MEA) solution (Sample S4-4), a 1 M aqueous solution of sodium hydroxide (NaOH) (Sample S4-5), 2,6-pyridine-bis(iminoguanidine) (Sample S4-6), and a melamine formaldehyde (MF) nanoporous network (Sample S4-7).

TABLE 5

| | | Moles of CO₂ | Moles of CO₂ |
|---|---|---|---|
| | | per 1 mole of | per 1 gram of |
| Sample | Material | sorbent | sorbent |
| S4-1 | SMFG | 3.31 | 0.0076 |
| S4-2 | MFG | 3.89-4.94 | 0.015 |
| S4-3 | 0.01M BTIG solution | 1.46 | 0.0044 |
| S4-4 | 30% MEA solution | 0.67 | 0.011 |
| S4-5 | 1M NaOH | 0.45 | 0.011 |
| S4-6 | PyBIGH | 0.50 | 0.0020 |
| S4-7 | MF nanoporous network | — | 0.019 |

Overall, the data in Table 5 indicated that embodiments of the present disclosure significantly outperform conventional CO₂ sorbents. For example, while comparative examples (Samples S4-3 to S4-7) showed, at most, 1.46 moles CO₂ absorbed per 1 mole of sorbent, it was determined that the example SMFG sorbent was able to absorb more than twice that amount (Sample S4-1: 3.31 moles CO₂ per 1 mole MFG sorbent)) and the example MFG sorbent was able to absorb more than three times that amount (Sample S4-2: 3.89-4.94 moles CO₂ per 1 mole MFG sorbent).

The determined values for the moles of CO₂ per 1 gram of sorbent is driven by the molecular weight of the sorbent. For example, 1 gram of SMFG is about 0.0025 moles while 1 gram of NaOH is 0.025 moles. Use of NaOH as sorbent (10× the number of moles) only achieves about 1.4× the amount of CO₂ absorbed than SMFG. Overall, a lower number of moles of SMFG and MFG performs more work than conventional sorbents. It was also noted that BTIG (comparative example 1) is a trichelating ligand where CO₂ can complex with three guanidine moieties whereas SMFG and MFG include only two ligands that can bind or complex CO₂.

### Example 4: CO₂ Capture: Sorbent Recyclability

Sorbent recyclability over multiple carbon dioxide gas absorption desorption cycles was tested. For this example, sorbent was made according to the following procedure: Glyoxal (40 wt % aqueous solution, Sigma Aldrich, CAS No. 107-22-2) and guanyl urea sulfate (TCI, CAS No. 591-01-5) were reacted in a 2:1 molar ratio in ethanol for 4 hours at 65° C. The reacted material was washed with ethanol and diethyl ether and dried to obtain the resultant carbon dioxide sorbent molecule as a white solid powder. The sorbent synthesized included a mixture of:

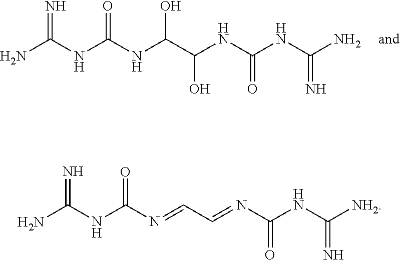 [SMILES: N=C(N)NC(=O)NC(O)C(O)NC(=O)NC(=N)N ; N=C(N)NC(=O)/N=C/C=N/C(=O)NC(=N)N]

32 g of the synthesized sorbent molecule was mixed with water to form a ˜12 wt % aqueous solution. Free base was prepared by adding 50 wt % caustic solution (NaOH) to replace all the sulfate ions from the sorbent molecule and make it available for carbon capture. Caustic addition solubilized the sorbent molecule in water. A sufficient amount of caustic solution was added to achieve a pH between 12 and 13 before sparging with a pure CO₂ gas stream. The liquid free base was transferred to an impinger tube attached to a CO₂ gas cylinder.

### Absorption-Desorption Cycle 1

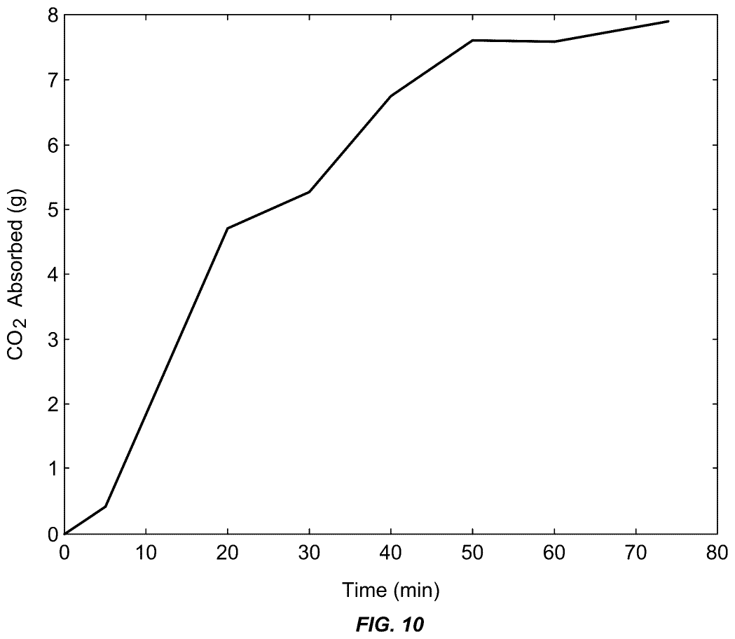

Absorption 1: Pure CO₂ was sparged at ˜0.45 standard liters per minute (SLPM) and mass gain monitored every 10 min. Sparging was stopped once there was no further gain in mass. CO₂ was absorbed partly by the sorbent and partly by the caustic solution. The sorbent molecule and caustic solution absorbed CO₂ to form a white cloudy slurry in water within 2-3 minutes of sparging. A total of about 7.94 g of CO₂ was absorbed in 74 minutes of total sparging (FIG. 10). Theoretically, there are two active sites for CO₂ absorption per sorbent molecule. The slurry was filtered, and the residue was washed with water and dried in ambient air to yield 15.96 g of sorbent-CO₂ complex as a solid, coarse powder that was light beige in color. TGA-MIR confirmed ˜29.4% weight loss (resulting from water and CO₂ combined) upon exposing the sorbent-CO₂ complex to the temperature ramp. The TGA data also showed that weight loss onset occurred at a temperature of about 62° C. and maximum loss occurred between about 90° C. and about 100° C.

Desorption 1: 8 g of sorbent-CO₂ complex was placed in a vacuum oven under full vacuum (−42 cm Hg) at 80° C. A weight loss of 25.25% of the sorbent-CO₂ complex was observed after 28 minutes in the vacuum oven, providing a yield after desorption of about 5.98 g. Complete desorption, up to 29.4% weight loss, was not performed for the absorption-desorption experiments.

### Absorption-Desorption Cycle 2

5.77 g of regenerated sorbent was added to water to make ˜12 wt % aqueous slurry. 50 wt % caustic solution was added to solubilize the regenerated sorbent. CO₂ was sparged at ˜0.45 SLPM for 76 minutes with a total CO₂ absorption of about 3.4 g. The solution turned cloudy within 1 minute of sparging. The slurry was filtered, and the resulting residue was washed with water and dried in ambient air to yield 4.18 g of sorbent-CO₂ complex as a powder. TGA data on the sorbent-CO₂ complex showed that the desorption onset was, again, around 62° C., but that the maximum weight loss shifted slightly to the right and occurred between 100° C. and 110° C. A weight loss of 28% was observed after 46 minutes in the vacuum oven (at 80° C., −42 cm Hg).

### Absorption-Desorption Cycle 3

The same process as the above cycles was performed. Here, regenerated sorbent obtained from cycle 2 was converted to free base before sparging CO₂. The slurry was filtered, and the resulting residue was washed with water and dried in ambient air to yield sorbent-CO₂ complex as a powder. Further absorption-desorption cycles may be performed.

Embodiments described herein generally relate to carbon dioxide sorbent molecules and to processes for forming carbon dioxide sorbent molecules. Embodiments described herein also generally relate to processes for CO₂ absorption and CO₂ desorption. For CO₂ absorption and CO₂ desorption, a carbon dioxide sorbent molecule can be in the form of a solution or in a solid state. Embodiments described herein can outperform conventional CO₂ capture technologies. In addition, carbon dioxide sorbent molecules can be regenerated and recycled for further use after desorption of CO₂.

### Embodiments Listing

The present disclosure provides, among others, the following aspects, each of which can be considered as optionally including any alternate embodiments:

Clause 1. A composition for absorbing or desorbing carbon dioxide (CO₂), the composition comprising a carbon dioxide sorbent molecule, the carbon dioxide sorbent molecule comprising a melamine-formaldehyde adduct or reaction product modified with an organoamine source, the organoamine source being different from melamine.

Clause 2. A composition for absorbing or desorbing carbon dioxide (CO₂), the composition comprising: a carbon dioxide sorbent molecule, the carbon dioxide sorbent molecule comprising a reaction product of: (a) an organoamine source; and (b) a reaction product of melamine and a formaldehyde, wherein the organoamine source is different from the melamine.

Clause 3. A composition for absorbing or desorbing carbon dioxide (CO₂), the composition comprising a carbon dioxide sorbent molecule, the carbon dioxide sorbent molecule comprising:
a core comprising a polymeric amino species, a polymeric phenol species, a partially oxidized material with aldehyde functionality, a partially oxidized material with ketone functionality, a mono-carboxylic acid species, a poly-carboxylic acid species, a mono-halogenated species, a poly-halogenated species, a mono-epoxidized species, poly-epoxidized species, a mono-glycidyl ether, a poly-glycidyl ether, a mono-isocyanate species, or poly-isocyanate species, a mono-alkyl-carbonate species, poly-alkyl-carbonate species, or combinations thereof; and
one or more ligands chemically bound to the core, at least one ligand of the one or more ligands comprising an organoamine group.

Clause 4. The composition of any one of the preceding Clauses, wherein the carbon dioxide sorbent molecule further comprises an ionizable functional group, a salt thereof, a polar non-ionizable functional group, or combinations thereof, the ionizable functional group, salt thereof, and polar non-ionizable functional group being different from the melamine and the organoamine source.

Clause 5. The composition of any one of the preceding Clauses, further comprising an aqueous solvent, an organic solvent, or combinations thereof.

Clause 6. The composition of any one of the preceding Clauses, further comprising one or more additives.

Clause 7. The composition of any one of the preceding claims, wherein the carbon dioxide sorbent molecule is represented by Formula (I-A):

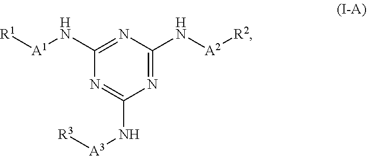

wherein:
   each of A¹, A², and A³ are, independently, CH₂ or CH₂OCH₂; and
   each of R¹, R², and R³ of Formula (I-A) are, independently, hydrogen, unsubstituted hydrocarbyl, a substituted hydrocarbyl, or a functional group comprising at least one element from Group 13-17 of the periodic table of the elements.

Clause 8. The composition of Clause 7, wherein one or more of R¹, R², or R³ of Formula (I-A) are an organoamine group.

Clause 9. The composition of Clause 8, wherein:
when one or more R¹, R², or R³ of Formula (I-A) are an organoamine group, the organoamine group is selected from the group consisting of a primary amine, secondary amine, a tertiary amine, a polyamine, an imine, an aminocarboxamidine, a polyimine, a Schiff base, an amine capable of forming an imine, an amine capable of forming a Schiff base, an amino acid, a polypeptide, or combinations thereof; and
when two or more of R¹, R², or R³ of Formula (I-A) are an organoamine group, each organoamine group is the same or different.

Clause 10. The composition of any one of Clauses 7-9, wherein:
at least one of R¹, R², or R³ of Formula (I-A) is an ionizable functional group, a salt thereof, or a polar non-ionizable functional group; and
the ionizable functional group, the salt thereof, or the polar non-ionizable functional group is different from the melamine and the organoamine group.

Clause 11. The composition of Clause 10, wherein the ionizable functional group comprises a sulfate, a sulfonate, a phosphate, a phosphonate, a carboxylic acid, or combinations thereof.

Clause 12. The composition of any one of Clauses 10 or 11, wherein the salt of the ionizable functional group comprises:
an anion of the ionizable functional group; and
a cation comprising an alkali metal, an alkali earth metal, a transition metal, an ammonium, an alkyl ammonium, a pyridinium, or combinations thereof.

Clause 13. The composition of any one of the preceding Clauses, wherein the carbon dioxide sorbent molecule comprises one or more of:

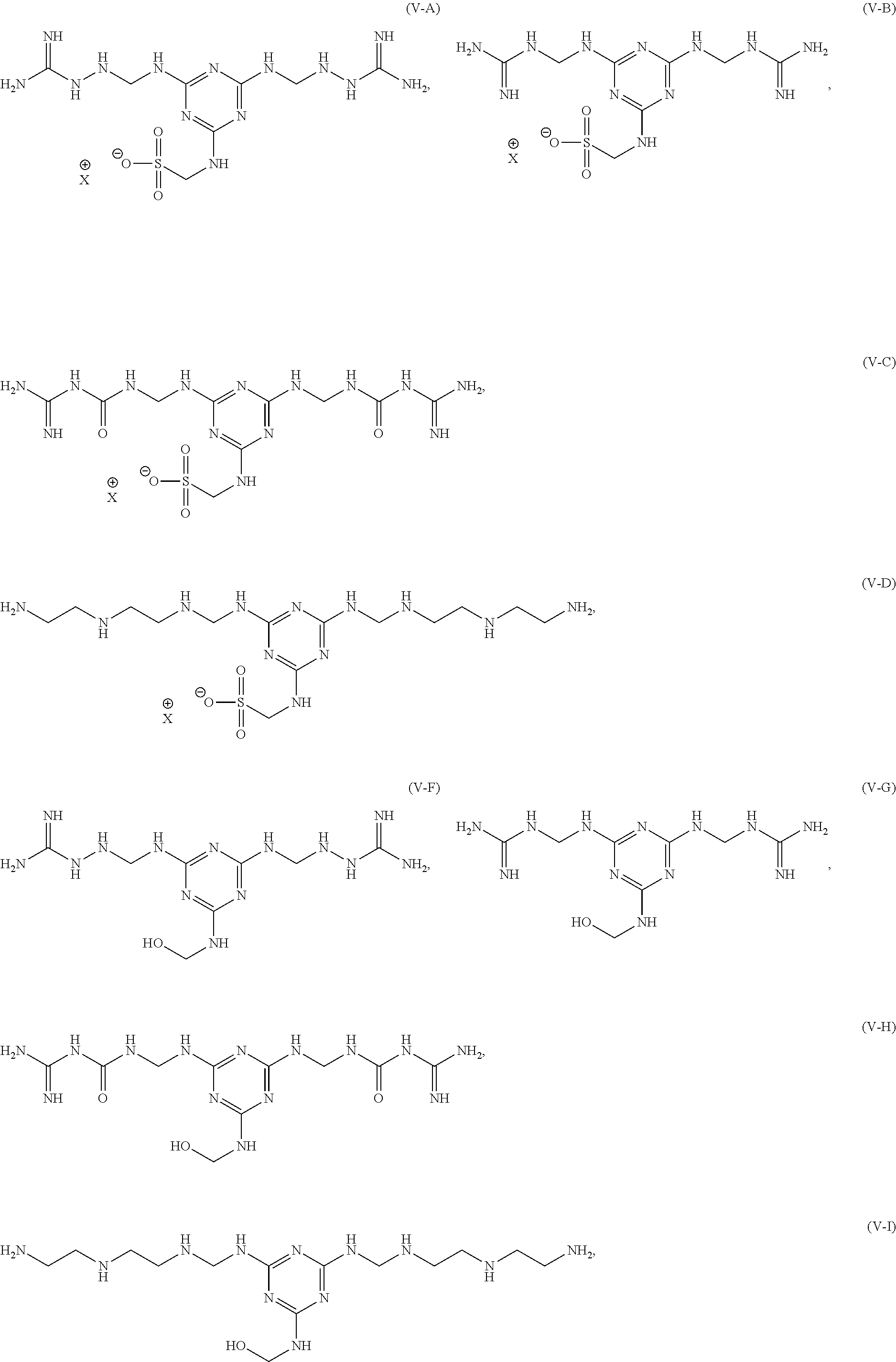

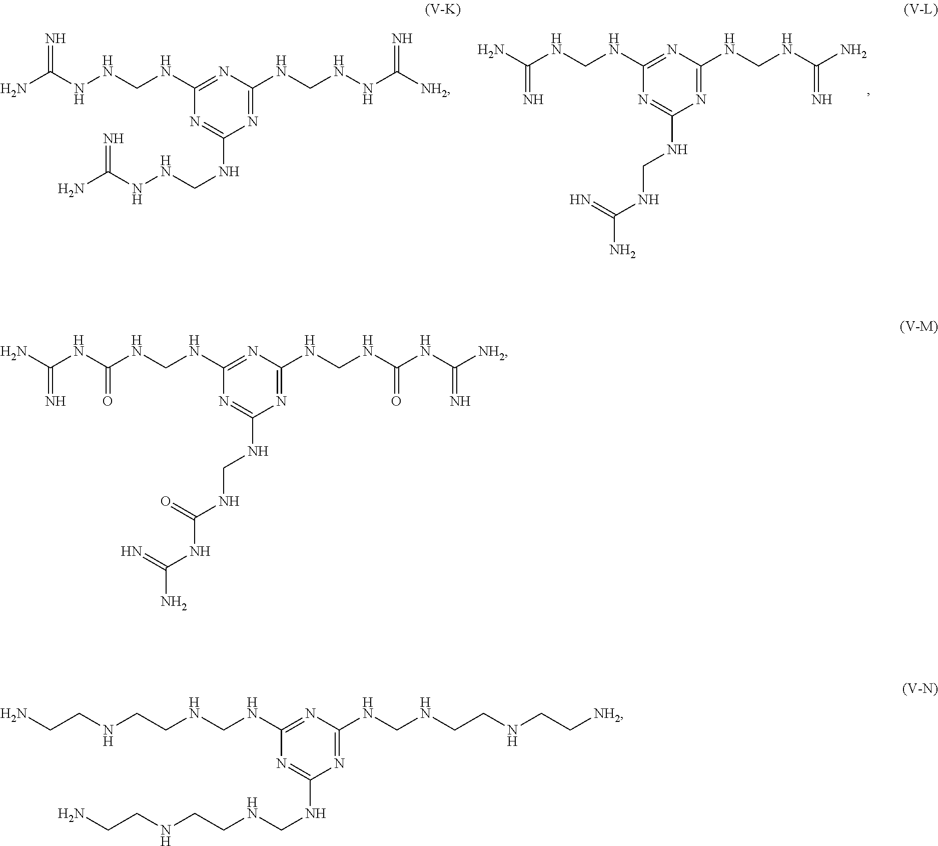 [SMILES: N=C(N)NNCNc1nc(NCNNC(=N)N)nc(NCNNC(=N)N)n1 ; N=C(N)NCNc1nc(NCNC(=N)N)nc(NCNC(=N)N)n1 ; N=C(N)NC(=O)NCNc1nc(NCNC(=O)NC(=N)N)nc(NCNC(=O)NC(=N)N)n1 ; NCCNCCNCNc1nc(NCNCCNCCN)nc(NCNCCNCCN)n1]

wherein: each X⁺ when present is, independently, an alkali metal, an alkali earth metal, a transition metal, an ammonium, an alkyl ammonium, a pyridinium, or combinations thereof.

Clause 14. The composition of any one of the preceding Clauses, wherein the carbon dioxide sorbent molecule comprises one or more of:

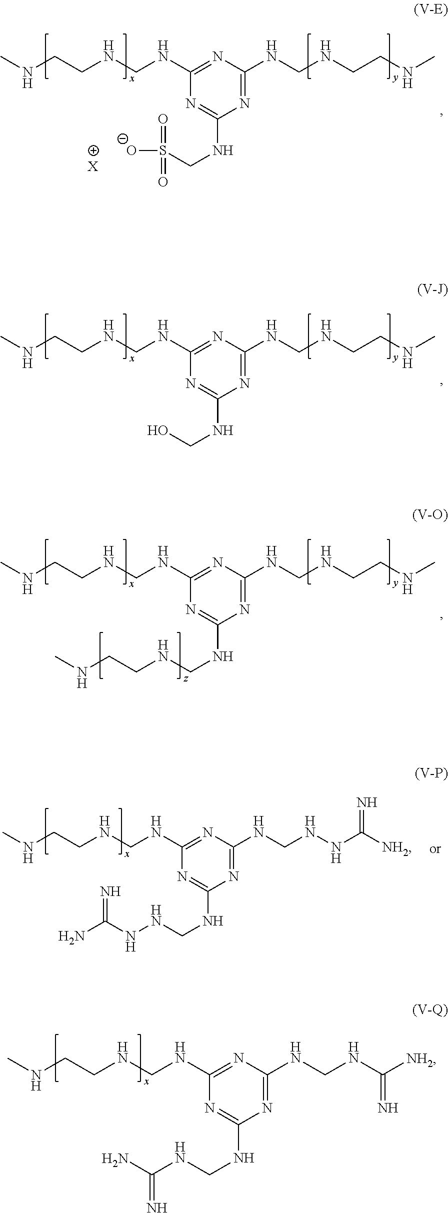

wherein: X⁺ when present is an alkali metal, an alkali earth metal, a transition metal, an ammonium, an alkyl ammonium, a pyridinium, or combinations thereof; and each x, y, and z in Formulas, when present, is, independently.

Clause 15. A process for forming a carbon dioxide sorbent molecule, the process comprising:
forming a methylolated melamine by reacting a first mixture comprising melamine and a source of formaldehyde;
reacting a second mixture comprising the methylolated melamine and an ionizable functional group source, a salt group source, a polar non-ionizable functional group source or combinations thereof to form a mono-substituted methylolated melamine, the ionizable functional group source, salt group source, and polar non-ionizable functional group source is different from the melamine; and
reacting a third mixture comprising the mono-substituted methylolated melamine with an organoamine source to form a carbon dioxide sorbent molecule, the organoamine source is different from melamine, the ionizable functional group source, the salt group source, and the polar non-ionizable functional group source.

Clause 16. The process of Clause 15, wherein the carbon dioxide sorbent molecule comprises the carbon dioxide sorbent molecule of any one of Clauses 1-14.

Clause 17. The process of any one of Clauses 15 or 16, wherein the carbon dioxide sorbent molecule comprises:

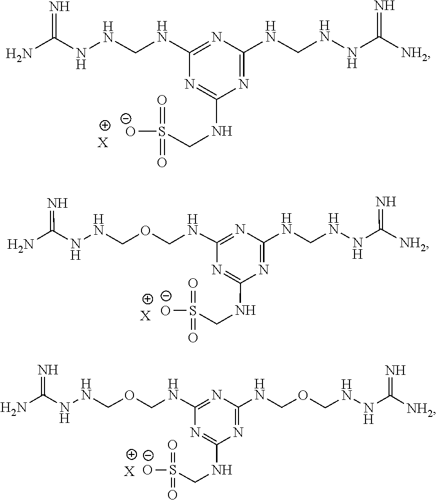

an ion thereof, or combinations thereof, wherein: each X⁺ is, independently, an alkali metal cation, an alkali earth metal cation, a transition metal cation, an ammonium cation, an alkyl ammonium cation, a pyridinium cation, a cationic species, or combinations thereof.

Clause 18. A process for forming a carbon dioxide sorbent molecule, the process comprising:
forming a methylolated melamine by reacting a first mixture comprising melamine and a source of formaldehyde; and
reacting a second mixture comprising the methylolated melamine and an organoamine source to form a carbon dioxide sorbent molecule, the organoamine source is different from melamine.

Clause 19. The process of Clause 18, wherein the carbon dioxide sorbent molecule comprises the carbon dioxide sorbent molecule of any one of Clauses 1-14.

Clause 20. The process of any one of Clauses 18 or 19, wherein the carbon dioxide sorbent molecule comprises:

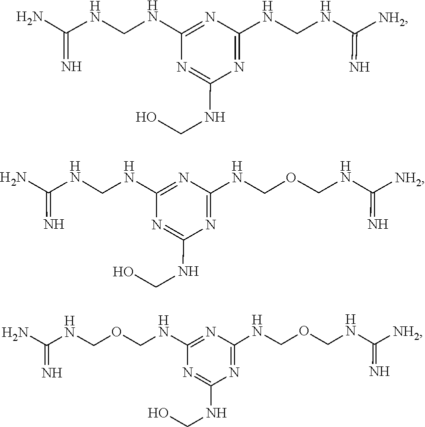 [SMILES: N=C(N)NCNc1nc(NCO)nc(NCNC(=N)N)n1 ; N=C(N)NCNc1nc(NCO)nc(NCOCNC(=N)N)n1 ; N=C(N)NCOCNc1nc(NCO)nc(NCOCNC(=N)N)n1]

an ion thereof, or combinations thereof.

Clause 21. A process for capturing carbon dioxide (CO₂), comprising:
introducing a gas stream or gas source comprising CO₂ with a composition comprising a carbon dioxide sorbent molecule, the carbon dioxide sorbent molecule comprising an organoamine group; and
forming a CO₂-enriched composition.

Clause 22. The process of Clause 21, wherein the CO₂-enriched composition comprises CO₂ bound to the carbon dioxide sorbent molecule.

Clause 23. The process of Clause 22, wherein the CO₂ bound to the carbon dioxide sorbent molecule is in the form of a carbonate (CO₃²⁻), a bicarbonate (HCO₃⁻), or combinations thereof.

Clause 24. The process of any one of Clauses 22 or 23, wherein the CO₂ bound to the carbon dioxide sorbent molecule is in the form of a salt comprising: a cation comprising the carbon dioxide sorbent molecule; and an anion comprising a carbonate (CO₃²⁻), a bicarbonate (HCO₃⁻), or combinations thereof.

Clause 25. The process of any one of Clauses 21-24, further comprising:
removing the CO₂ from the CO₂-enriched composition by subjecting the CO₂-enriched composition to heat, acidic conditions, basic conditions, hydrolysis, electrolysis, electromagnetic radiation, ionic exchange, elevated pressure, vacuum pressure, or combinations thereof; and
regenerating the carbon dioxide sorbent molecule.

Clause 26. The process of Clause 25, wherein, when the removing the CO₂ from the CO₂-enriched composition includes subjecting the CO₂-enriched composition to heat, the subjecting the subjecting the CO₂-enriched composition to heat comprises: heating the CO₂-enriched composition at a temperature that is from about 40° C. to about 250° C.

Clause 27. The process of Clause 26, wherein the temperature is from about 40° C. to about 160° C.

Clause 28. The process of any one of Clauses 25-27, wherein the removed CO₂ is quarantined for storage, converted into a chemical substance or feedstock, or combinations thereof.

Clause 29. A process for capturing carbon dioxide (CO₂), comprising:
contacting a gas stream or gas source comprising CO₂ with a composition comprising a carbon dioxide sorbent molecule, the carbon dioxide sorbent molecule comprising an organoamine group; and
precipitating a complex comprising CO₂ bound to the carbon dioxide sorbent molecule.

Clause 30. The process of Clause 29, wherein the CO₂ bound to the carbon dioxide sorbent molecule is in the form of a carbonate (CO₃²⁻), a bicarbonate (HCO₃⁻), or combinations thereof.

Clause 31. The process of any one of Clauses 29 or 30, wherein the CO₂ bound to the carbon dioxide sorbent molecule is in the form of a salt comprising:
a cation comprising the carbon dioxide sorbent molecule; and
an anion comprising (CO₃²⁻), a bicarbonate (HCO₃⁻), or combinations thereof.

Clause 32. The process of any one of Clauses 29-31, further comprising:
removing the CO₂ from the complex by subjecting the complex to heat, acidic conditions, basic conditions, hydrolysis, electrolysis, electromagnetic radiation, ionic exchange, elevated pressure, vacuum pressure, or combinations thereof; and
regenerating the carbon dioxide sorbent molecule.

Clause 33. The process of Clause 32, wherein, when the removing the CO₂ from the complex includes subjecting the complex to heat, the subjecting the subjecting the sorbent-CO₂ complex to heat comprises:
heating the complex at a temperature that is from about 40° C. to about 250° C.

Clause 34. The process of Clause 33, wherein the temperature is from about 40° C. to about 160° C.

Clause 35. The process of any one of Clauses 29-34, wherein the removed CO₂ is quarantined for storage, converted into a chemical substance or feedstock, or combinations thereof.

Clause 36. A composition for absorbing or desorbing CO₂, comprising: a carbon dioxide sorbent molecule comprising a melamine-formaldehyde reaction product modified with an organoamine source, the organoamine source being different from melamine.

Clause 37. A composition of Clause 36, wherein the carbon dioxide sorbent molecule further comprises an ionizable functional group, a polar non-ionizable functional group, or combinations thereof bonded to the melamine-formaldehyde reaction product, the ionizable functional group and polar non-ionizable functional group being different from melamine and the organoamine source.

Clause 38. A composition of any one of Clauses 36 or 37, wherein the organoamine source comprises a primary amine, secondary amine, a tertiary amine, an imine, an aminocarboxamidine, a Schiff base, or combinations thereof.

Clause 39. A composition of any one of Clauses 36-38, further comprising a solvent.

Clause 40. A composition of Clause 39, wherein the solvent comprises water, an organic solvent, or combinations thereof.

Clause 41. A composition of Clause 40, wherein the organic solvent comprises an alcohol solvent.

Clause 42. A composition of any one of Clauses 36-41, further comprising an additive.

Clause 43. A composition of Clause 42, wherein the additive comprises a metal hydroxide.

Clause 44. A composition of any one of Clauses 36-43, wherein the carbon dioxide sorbent molecule is represented by Formula (I-A):

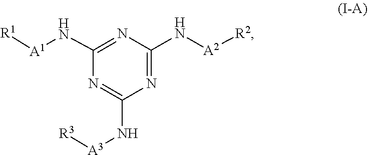

wherein:
each of A¹, A², and A³ of Formula (I-A) is, independently, CH₂ or CH₂OCH₂;
each of R¹ and R² of Formula (I-A) is, independently, an organoamine comprising

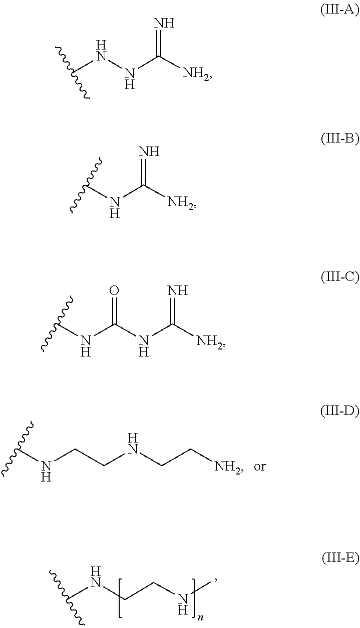

wherein the wavy bonds of Formulas (III-A)-(III-E) represent a connection to A¹ or A²; and
R³ of Formula (I-A) is an organoamine of formula (III-A)-(III-E), an ionizable functional group, or a polar non-ionizable functional group.

Clause 45. A composition of Clause 44, wherein: when R³ of Formula (I-A) is the ionizable functional group, the ionizable functional group is selected from the group consisting of sulfate, a sulfonate, a phosphate, a phosphonate, a carboxylic acid, and combinations thereof; when R³ of Formula (I-A) is the polar non-ionizable functional group, the polar non-ionizable functional group is hydroxyl (—OH); or combinations thereof.

Clause 46. A composition of any one of Clauses 36-43, wherein the carbon dioxide sorbent molecule comprises one or more of:

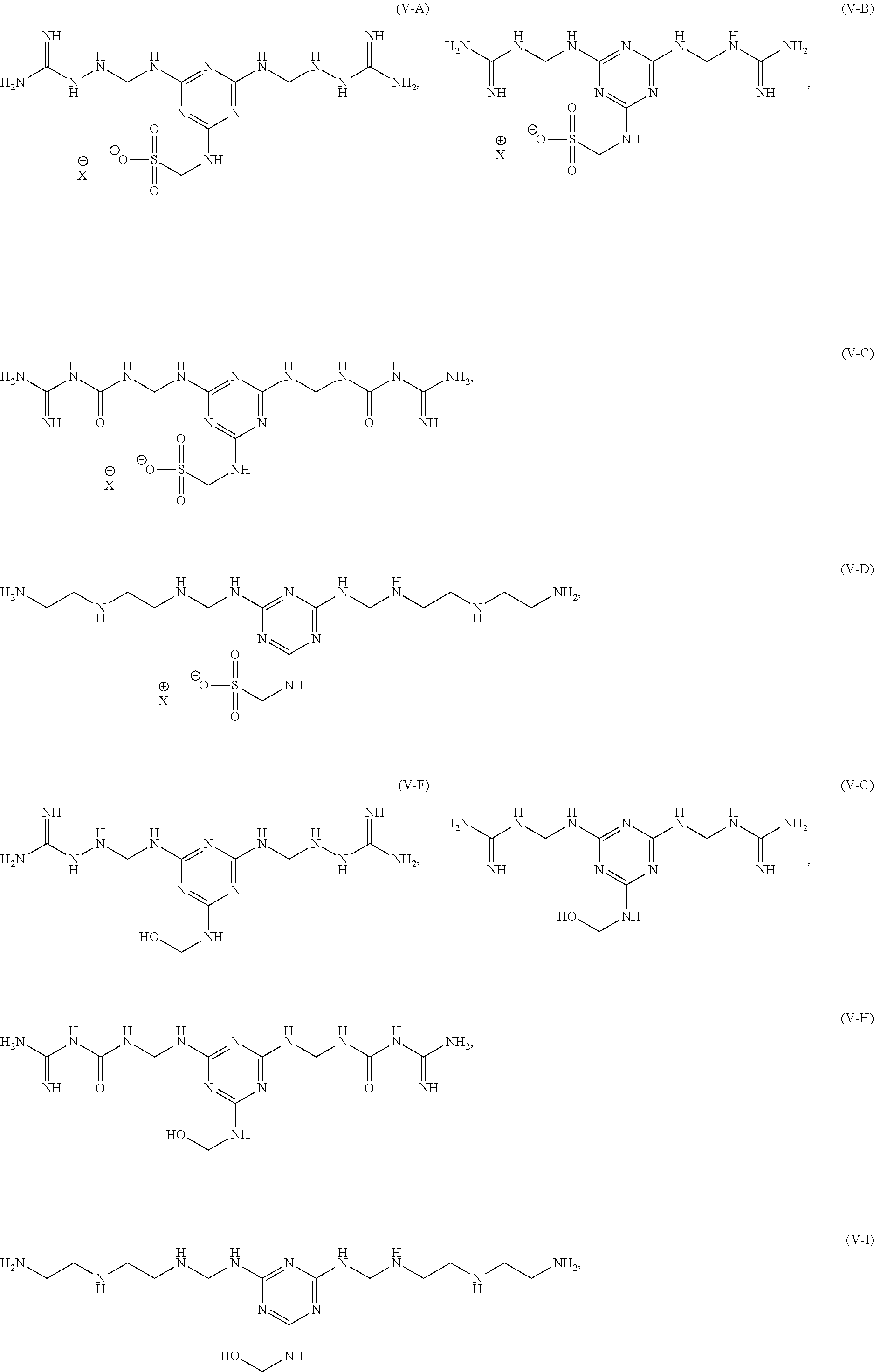

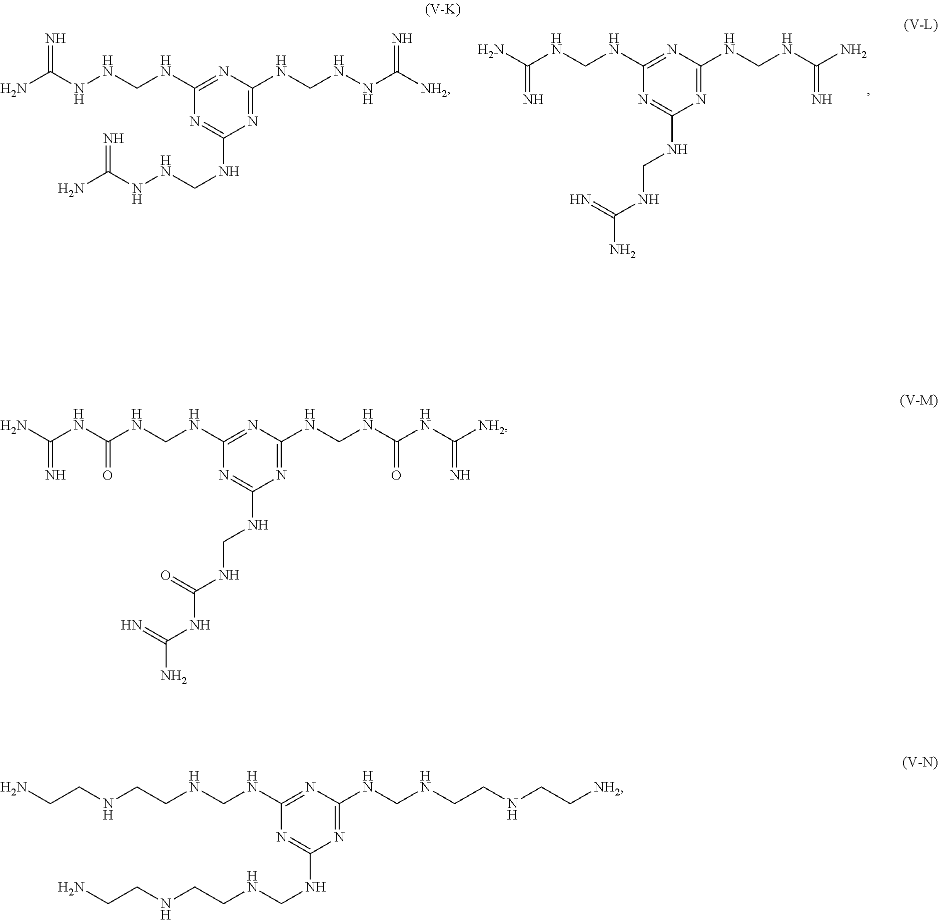 [SMILES: N=C(N)NNCNc1nc(NCNNC(=N)N)nc(NCNNC(=N)N)n1 ; N=C(N)NCNc1nc(NCNC(=N)N)nc(NCNC(=N)N)n1 ; N=C(N)NC(=O)NCNc1nc(NCNC(=O)NC(=N)N)nc(NCNC(=O)NC(=N)N)n1 ; NCCNCCNCNc1nc(NCNCCNCCN)nc(NCNCCNCCN)n1]

wherein: each X⁺ in Formulas (V-A)-(V-D) is, independently, an alkali metal cation, an alkali earth metal cation, a transition metal cation, an ammonium cation, an alkyl ammonium cation, a pyridinium cation, or combinations thereof.

Clause 47. A composition of any one of Clauses 36-43, wherein the carbon dioxide sorbent molecule comprises one or more of:

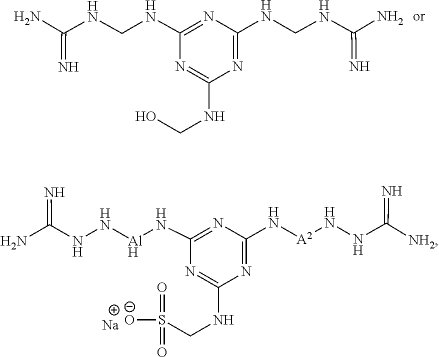

wherein: each of Al and A² is, independently, CH₂ or CH₂OCH₂.

Clause 48. A composition for absorbing or desorbing CO₂, the composition comprising: a carbon dioxide sorbent molecule comprising a reaction product of: glyoxal; and an organoamine source comprising a urea functional group.

Clause 49. A composition of Clause 48, wherein the organoamine source comprises guanyl urea.

Clause 50. A composition of any one of Clauses 48 or 49, wherein the carbon dioxide sorbent molecule comprises one or more of:

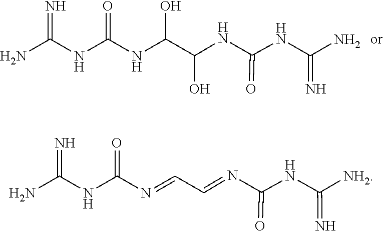 [SMILES: N=C(N)NC(=O)NC(O)C(O)NC(=O)NC(=N)N ; N=C(N)NC(=O)/N=C/C=N/C(=O)NC(=N)N]

Clause 51. A composition of any one of Clauses 48-50, further comprising a solvent, an additive, or combinations thereof.

Clause 52. A process, comprising:
contacting a gas stream comprising CO₂ with a composition comprising water, optionally an additive, and a carbon dioxide sorbent molecule represented by Formula (I-A):

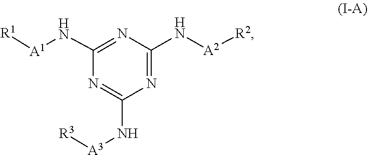

wherein:
   each of A¹, A², and A³ of Formula (I-A) is, independently, CH₂ or CH₂OCH₂;
   each of R¹ and R² of Formula (I-A) is, independently, an organoamine comprising

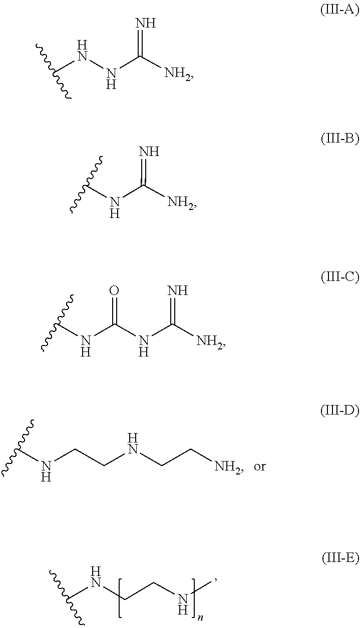

wherein the wavy bonds of Formulas (III-A)-(III-E) represent a connection to Al or A²; and
R³ of Formula (I-A) is an organoamine of formula (III-A)-(III-E), an ionizable functional group, or a polar non-ionizable functional group; and
precipitating a sorbent-CO₂ complex comprising CO₂ bound to the carbon dioxide sorbent molecule.

Clause 53. A process of Clause 52, further comprising:
desorbing the CO₂ from the sorbent-CO₂ complex by subjecting the sorbent-CO₂ complex to heat, acidic conditions, basic conditions, hydrolysis, electrolysis, electromagnetic radiation, ionic exchange, elevated pressure, vacuum pressure, or combinations thereof; and
regenerating the carbon dioxide sorbent molecule.

Clause 54. A process of Clause 53, wherein, when the desorbing the CO₂ from the sorbent-CO₂ complex includes subjecting the sorbent-CO₂ complex to heat, the subjecting the sorbent-CO₂ complex to heat comprises heating the sorbent-CO₂ complex at a temperature that is from about 40° C. to about 250° C.

Clause 55. A process of Clause 54, wherein the sorbent-CO₂ complex is heated at a temperature from about 40° C. to about 160° C.

Clause 56. A process of any one of Clause 52-55, wherein the additive is present and comprises a metal hydroxide.

Clause 57. A process, comprising:
contacting a gas stream comprising CO₂ with a composition comprising water, optionally an additive, and a carbon dioxide sorbent molecule comprising one or more of:

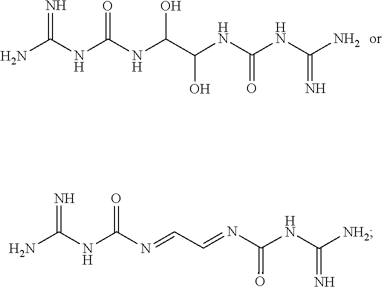 [SMILES: N=C(N)NC(=O)NC(O)C(O)NC(=O)NC(=N)N ; N=C(N)NC(=O)/N=C/C=N/C(=O)NC(=N)N]

and
precipitating a sorbent-CO₂ complex comprising CO₂ bound to the carbon dioxide sorbent molecule.

Clause 58. A process of Clause 57, further comprising:
desorbing the CO₂ from the sorbent-CO₂ complex by subjecting the sorbent-CO₂ complex to heat, acidic conditions, basic conditions, hydrolysis, electrolysis, electromagnetic radiation, ionic exchange, elevated pressure, vacuum pressure, or combinations thereof; and
regenerating the carbon dioxide sorbent molecule.

Clause 59. A process of Clause 58, wherein, when the desorbing the CO₂ from the sorbent-CO₂ complex includes the subjecting the sorbent-CO₂ complex to heat, the subjecting the sorbent-CO₂ complex to heat comprises heating the sorbent-CO₂ complex at a temperature that is from about 40° C. to about 250° C., such as from about 40° C. to about 160° C.

Clause 60. A process of any one of Clauses 57-60, wherein the additive is present and comprises a metal hydroxide.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a carbon dioxide sorbent molecule” includes aspects comprising one, two, or more carbon dioxide sorbent molecules, unless specified to the contrary or the context clearly indicates only one carbon dioxide sorbent molecule is included.

While the foregoing is directed to aspects of the present disclosure, other and further aspects of the disclosure may be devised without departing from the basic scope thereof, and the scope thereof is determined by the claims that follow.

What is claimed is:

1. A composition for absorbing or desorbing CO₂, comprising:
a carbon dioxide sorbent molecule comprising a melamine-formaldehyde reaction product modified with an organoamine source, the organoamine source being different from melamine.

2. A composition of claim 1, wherein the carbon dioxide sorbent molecule further comprises an ionizable functional group, a polar non-ionizable functional group, or combinations thereof bonded to the melamine-formaldehyde reaction product, the ionizable functional group and polar non-ionizable functional group being different from melamine and the organoamine source.

3. A composition of any one of claims 1 or 2, wherein the organoamine source comprises a primary amine, secondary amine, a tertiary amine, an imine, an aminocarboxamidine, a Schiff base, or combinations thereof.

4. A composition of any one of claims 1-3, further comprising a solvent.

5. A composition of claim 4, wherein the solvent comprises water, an organic solvent, or combinations thereof.

6. A composition of claim 5, wherein the organic solvent comprises an alcohol solvent.

7. A composition of any one of claims 1-5, further comprising an additive.

8. A composition of claim 7, wherein the additive comprises a metal hydroxide.

9. A composition of any one of claims 1-8, wherein the carbon dioxide sorbent molecule is represented by Formula (I-A): 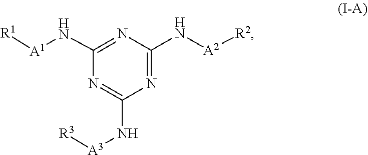
wherein:
each of A¹, A², and A³ of Formula (I-A) is, independently, CH₂ or CH₂OCH₂;
each of RI and R² of Formula (I-A) is, independently, an organoamine comprising 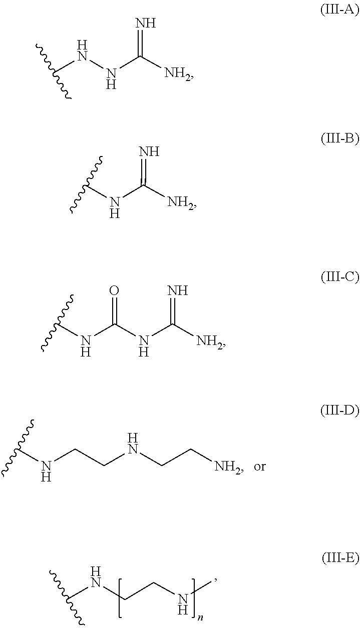
wherein the wavy bonds of Formulas (III-A)-(III-E) represent a connection to A¹ or A²; and
R³ of Formula (I-A) is an organoamine of formula (III-A)-(III-E), an ionizable functional group, or a polar non-ionizable functional group.

10. A composition of claim 9, wherein:
when R³ of Formula (I-A) is the ionizable functional group, the ionizable functional group is selected from the group consisting of sulfate, a sulfonate, a phosphate, a phosphonate, a carboxylic acid, and combinations thereof;
when R³ of Formula (I-A) is the polar non-ionizable functional group, the polar non-ionizable functional group is hydroxyl (—OH); or
combinations thereof.

11. A composition of any one of claims 1-8, wherein the carbon dioxide sorbent molecule comprises one or more of: 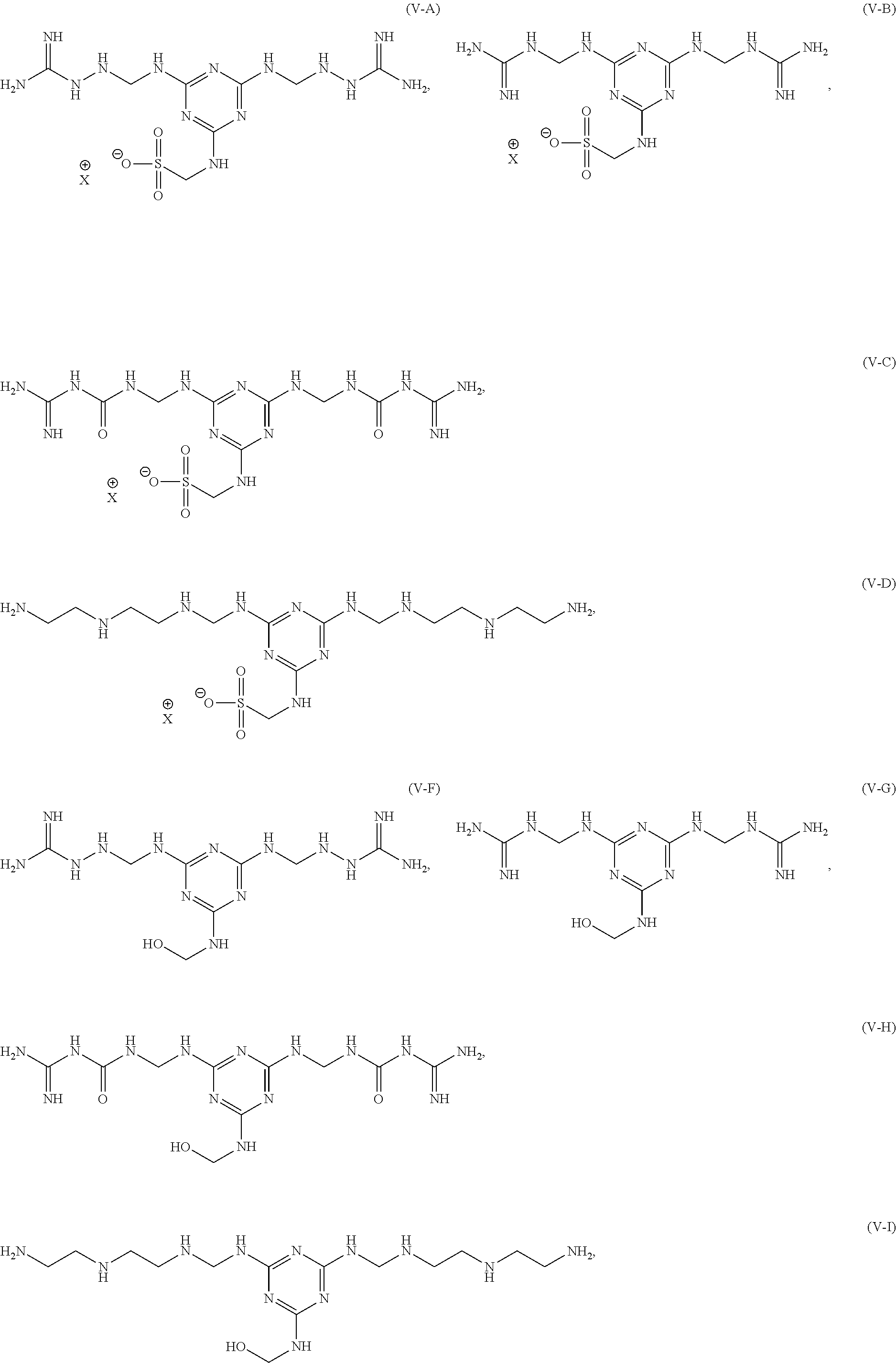 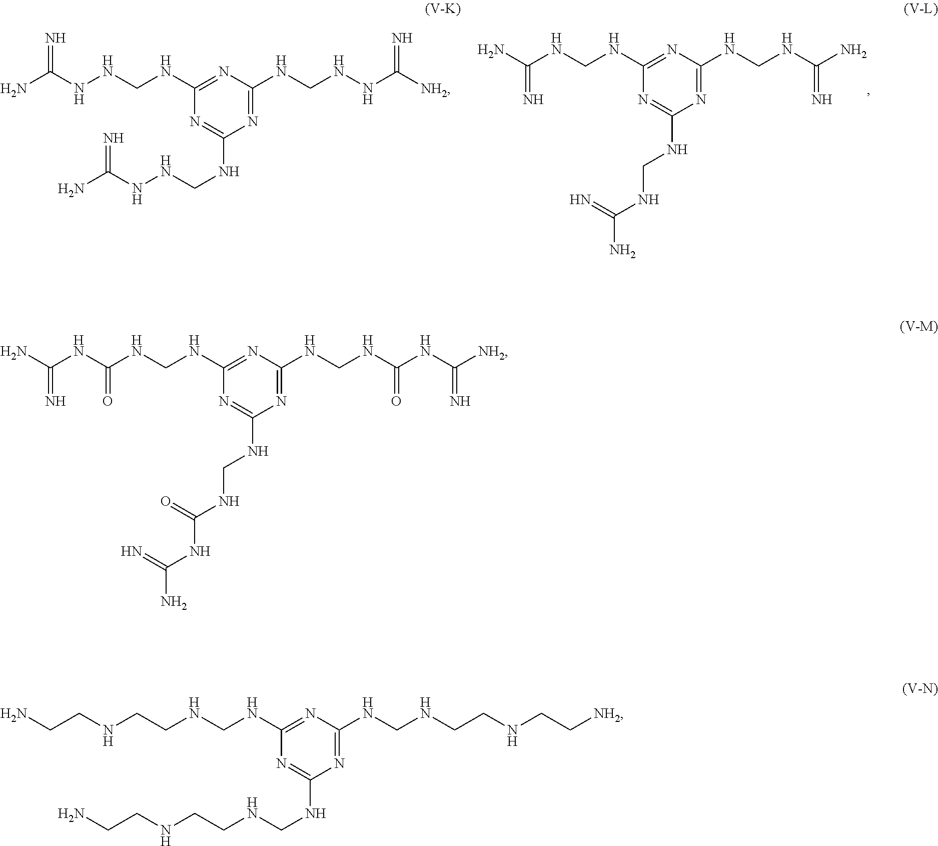 [SMILES: N=C(N)NNCNc1nc(NCNNC(=N)N)nc(NCNNC(=N)N)n1 ; N=C(N)NCNc1nc(NCNC(=N)N)nc(NCNC(=N)N)n1 ; N=C(N)NC(=O)NCNc1nc(NCNC(=O)NC(=N)N)nc(NCNC(=O)NC(=N)N)n1 ; NCCNCCNCNc1nc(NCNCCNCCN)nc(NCNCCNCCN)n1]
wherein:
each X⁺ in Formulas (V-A)-(V-D) is, independently, an alkali metal cation, an alkali earth metal cation, a transition metal cation, an ammonium cation, an alkyl ammonium cation, a pyridinium cation, or combinations thereof.

12. A composition of any one of claims 1-8, wherein the carbon dioxide sorbent molecule comprises one or more of: 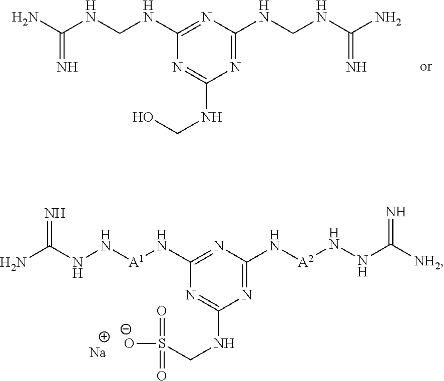
wherein: each of Al and A² is, independently, CH₂ or CH₂OCH₂.

13. A composition for absorbing or desorbing CO₂, the composition comprising:
a carbon dioxide sorbent molecule comprising a reaction product of:
glyoxal; and
an organoamine source comprising a urea functional group.

14. A composition of claim 13, wherein the organoamine source comprises guanyl urea.

15. A composition of any one of claims 13 or 14, wherein the carbon dioxide sorbent molecule comprises one or more of:

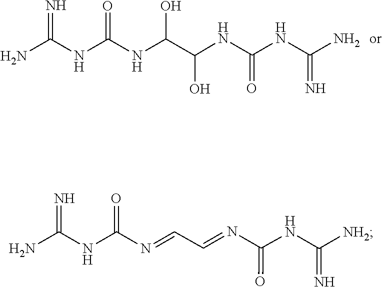 [SMILES: N=C(N)NC(=O)NC(O)C(O)NC(=O)NC(=N)N ; N=C(N)NC(=O)/N=C/C=N/C(=O)NC(=N)N]

16. A composition of any one of claims 13-15, further comprising a solvent, an additive, or combinations thereof.

17. A process, comprising:
contacting a gas stream comprising CO₂ with a composition comprising water, optionally an additive, and a carbon dioxide sorbent molecule represented by Formula (I-A): 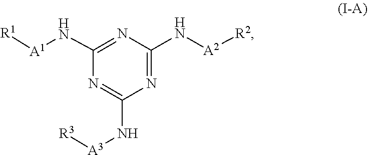
wherein:
each of A¹, A², and A³ of Formula (I-A) is, independently, CH₂ or CH₂OCH₂;
each of R¹ and R² of Formula (I-A) is, independently, an organoamine comprising 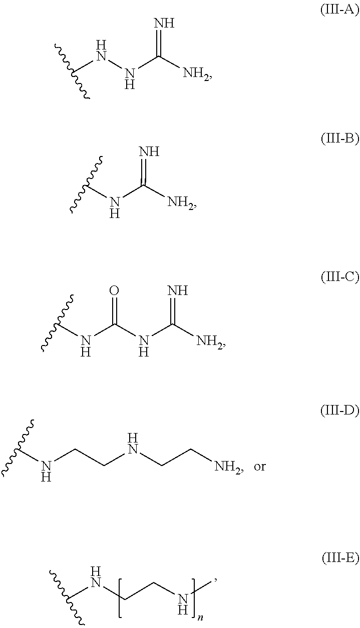
wherein the wavy bonds of Formulas (III-A)-(III-E) represent a connection to A¹ or A²; and
R³ of Formula (I-A) is an organoamine of formula (III-A)-(III-E), an ionizable functional group, or a polar non-ionizable functional group; and
precipitating a sorbent-CO₂ complex comprising CO₂ bound to the carbon dioxide sorbent molecule.

18. A process of claim 17, further comprising:
desorbing the CO₂ from the sorbent-CO₂ complex by subjecting the sorbent-CO₂ complex to heat, acidic conditions, basic conditions, hydrolysis, electrolysis, electromagnetic radiation, ionic exchange, elevated pressure, vacuum pressure, or combinations thereof; and
regenerating the carbon dioxide sorbent molecule.

19. A process of claim 18, wherein, when the desorbing the CO₂ from the sorbent-CO₂ complex includes subjecting the sorbent-CO₂ complex to heat, the subjecting the sorbent-CO₂ complex to heat comprises heating the sorbent-CO₂ complex at a temperature that is from about 40° C. to about 250° C.

20. A process of claim 19, wherein the sorbent-CO₂ complex is heated at a temperature from about 40° C. to about 160° C.

21. A process of any one of claims 17-20, wherein the additive is present and comprises a metal hydroxide.

22. A process, comprising:
contacting a gas stream comprising CO₂ with a composition comprising water, optionally an additive, and a carbon dioxide sorbent molecule comprising one or more of: 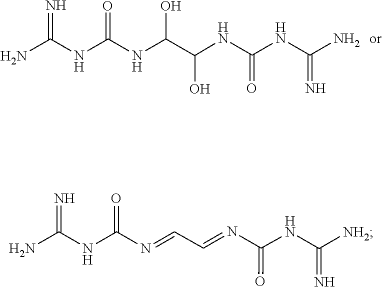 [SMILES: N=C(N)NC(=O)NC(O)C(O)NC(=O)NC(=N)N ; N=C(N)NC(=O)/N=C/C=N/C(=O)NC(=N)N]
precipitating a sorbent-CO₂ complex comprising CO₂ bound to the carbon dioxide sorbent molecule.

23. A process of claim 22, further comprising:
desorbing the CO₂ from the sorbent-CO₂ complex by subjecting the sorbent-CO₂ complex to heat, acidic conditions, basic conditions, hydrolysis, electrolysis, electromagnetic radiation, ionic exchange, elevated pressure, vacuum pressure, or combinations thereof; and
regenerating the carbon dioxide sorbent molecule.

24. A process of claim 23, wherein, when the desorbing the CO₂ from the sorbent-CO₂ complex includes the subjecting the sorbent-CO₂ complex to heat, the subjecting the sorbent-CO₂ complex to heat comprises heating the sorbent-CO₂ complex at a temperature that is from about 40° C. to about 250° C.

25. A process of any one of claims 22-24, wherein the additive is present and comprises a metal hydroxide.
